(19) United States
(12) Patent Application Publication
(10) Pub. No.: US 2006/0262992 A1
(43) Pub. Date: Nov. 23, 2006

(54) Method of and system for correcting image data, and its computer program

(75) Inventors: Takao Kuwabara, Kanagawa-ken (JP); Takeshi Kuwabara, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/435,761

(22) Filed: May 18, 2006

(30) Foreign Application Priority Data
May 18, 2005 (JP) 145087/2005

(51) Int. Cl. G06K 9/40

(52) U.S. Cl. 382/274

(57) ABSTRACT

In a method of correcting image data output from each of photo-sensors forming a plurality of line sensors arranged in a first direction, one of the plurality of line sensors is determined as a reference line sensor, and another line sensor adjacent to the reference line sensor is determined as an object line sensor to be corrected. A larger correction value is given to the image data value output from photo-sensor in the object line sensor nearer to an end of the reference line sensor facing the object line sensor.

### BACKGROUND OF THE INVENTION

1. Field of the Invention

This invention relates to a method of and a system for correcting image data output from each of photo-sensors forming a line sensor a plurality of which are arranged in one direction and a computer program for causing a computer to execute the method of correcting image data.

2. Description of the Related Art

There has been known a system in which image data representing an image on an object is obtained by causing a long line sensor comprising a plurality of line sensors each of which comprises a number of photo-sensors arranged in one direction and which are arranged in said one direction to scan the original in a direction perpendicular to said one direction. (See Japanese Unexamined Patent Publication No. 2004-166151)

Since the line sensors described above are formed by forming a plurality of photo-sensors on same substrates, the light receiving characteristics of the line sensors differ from each other though the light receiving characteristics of the photo-sensors in one line sensor do not substantially differ. Accordingly, for instance, when a predetermined amount of light which is in a relatively large range within the acceptable light receiving range of the photo-sensors is received by photo-sensors in each line sensor, the values of the image data (referred to as “image data values”, hereinbelow) output from the photo-sensors have been corrected so that they are continuous to each other. That is, the image data values have been corrected so that, when each image data is displayed as a visible image, an image density is smoothly connected without discontinuity at the border between a range of an image which is displayed by image data output from the photo-sensor of one line sensor and a range of an image which is displayed by image data output from the photo-sensor of another line sensor.

The light receiving characteristics means the relation between the amount of light which each of the sensors receives and the image data values which the sensor outputs in response to receipt of the light.

Correction of the image data values will be described with reference to FIG. 14. FIG. 14 shows the image data value which each photo-sensor outputs when a predetermined amount of light is received by each of the photo-sensors forming the line sensors with the abscissa X showing the position of each photo-sensor forming the long line sensor and the ordinate w showing the image data value output from the photo-sensor.

As can be seen from FIG. 14, before the correction, the image data value output from each photo-sensor in response to receipt of the predetermined amount of light is constant and Waz in the case of photo-sensors forming the line sensor Az, Wbz in the case of photo-sensors forming the line sensor Bz, and Wcz in the case of photo-sensors forming the line sensor Cz.

In order to connect the image data values from the line sensors, the image data value output from each photo-sensor is corrected so that to the image data values output from the photo-sensors Eae of the photo-sensors in the line sensor Az near to the line sensor Bz, are conformed the image data values output from the photo-sensors Eb1 of the line sensor Bz adjacent to the photo-sensors Eae and to the image data values output from the photo-sensors Ebe of the photo-sensors in the line sensor Bz near to the line sensor Cz, are conformed the image data values output from the photo-sensors Ec1 of the line sensor Cz adjacent to the photo-sensors Ebe.

That is, the correction is made to lower the image data value output from each photo-sensor of the line sensor Bz by Pb and to increase the image data value output from each photo-sensor of the line sensor Cz by Pc so long as they receives the predetermined amount of light. Thereby, the corrected image data values output from the photo-sensors forming the line sensors Az, Bz and Cz forming the long line sensors can be connected so that no step is generated and at the same time, the image data values output from the line sensors Az, Bz and Cz can conform to the value Waz.

By thus correcting the image data values, an image where discontinuity between adjacent line sensors is suppressed can be generated.

However, when a predetermined amount of weak light which is in a relatively small range within the acceptable light receiving range of the photo-sensors is projected onto a long line sensor which has been corrected so that the image data values output from the long line sensor are connected so that no step is generated in the image, the image data values output from photo-sensors of each of the line sensors Az, Bz and Cz can fluctuate though the average of the image data values output from photo-sensors of each of the line sensors Az, Bz and Cz conforms to each other. This fluctuation is due to production of each line sensor and though the difference in image data values between photo-sensors adjacent to each other in each line sensor which formed in a substrate is small, for instance, from one end of the line sensor toward the other end of the same, the image data values output from the photo-sensors can gradually increase or decrease.

When, for example, said predetermined amount of weak light is received by the long line sensor, the image data values output from the photo-sensors in the line sensor Az can be reduced toward the line sensor Bz (toward the direction of arrow +X), the image data values output from the photo-sensors in the line sensor Bz can be reduced toward the line sensor Cz (toward the direction of arrow +X) and the image data values output from the photo-sensors in the line sensor Cz can be reduced toward the direction of arrow +X as shown in FIG. 15.

In such a case, there is generated a substantial difference between image data values output from photo-sensors in the ends adjacent to each other in line sensors adjacent to each other though the image data values forming the long line sensor fluctuate by a small amount (indicated in FIG. 15 by a value Pk). That is, the image data value (shown by the broken line in FIG. 15) output from the photo-sensor Eb1 in the line sensor Bz adjacent to the photo-sensor Eae is larger by the value ab than the image data value output from the photo-sensor Eae in the line sensor Az near to the line sensor Bz, and the image data values are discontinuous here. Further, the image data value (shown by the broken line in FIG. 15) output from the photo-sensor Ec1 in the line sensor Cz adjacent to the photo-sensor Ebe is larger by the value ab than the image data value output from the photo-sensor Ebe in the line sensor Bz near to the line sensor Cz, and the image data values are discontinuous here.

Whereas, it is conceivable to apply the same technic as described above to the photo-sensors Eae and Eb1 between which the image data values are discontinuous and to the photo-sensors Ebe and Ec1 between which the image data values are discontinuous. That is, it is conceivable to reduce the image data value output from each photo-sensor in the line sensor Bz by ab and to reduce the image data value output from each photo-sensor in the line sensor Cz by αb+αc in a state where said predetermined amount of weak light is received by the long line sensor.

However, when such correction is carried out, the correction amounts given to each line sensor in response to the corrections accumulate though the image data values between which the image data values are discontinuous can be connected without a step (shown by the solid line in FIG. 15). And, there is a problem that the width of fluctuation (indicated at value βj in FIG. 15) of the image data value output from each of the photo-sensors forming the long line sensor upon receipt of an amount of weak light can become larger than that (indicated at value βk in FIG. 15) before the correction (βj>βk).

The above problem generally arises when a plurality of pieces of image data output from the line sensors which have received light carrying thereon image information and the like is corrected without being limited when correcting a plurality of pieces of image data output from the line sensors which have received an amount of weak light.

### SUMMARY OF THE INVENTION

In view of the foregoing observations and description, the primary object of the present invention is to provide a method of and a system for correcting image data which can connect image data values output from photo-sensors forming a plurality of line sensors which are arranged in one direction while suppressing increase of fluctuation of the image data value output from each of the photo-sensors, and a computer program for causing a computer to execute the method of correcting image data.

In accordance with the present invention, there is provided a first method of correcting image data which is output from each of photo-sensors forming a plurality of line sensors arranged in a first direction wherein the improvement comprises the steps of

determining one of the plurality of line sensors as a reference line sensor,

determining another line sensor adjacent to the reference line sensor as an object line sensor to be corrected, and

giving a larger correction value to the image data value output from a photo-sensor in the object line sensor nearer to an end of the reference line sensor facing the object line sensor so that the image data values output from photo-sensors in the object line sensor near to the end of the reference line sensor is connected to the image data value output from photo-sensors in the reference line sensor near to the end of the object line sensor facing the reference line sensor.

In the method, a larger correction value may be given to the image data value output from photo-sensor in the object line sensor which is nearer to the end of the reference line sensor with the image data values output from photo-sensor in the object line sensor which is in the end portion opposite to the end of the reference line sensor fixed.

The photo-sensor may be a CCD element.

The end portions of line sensors adjacent to each other out of a plurality of the line sensors arranged in the first direction may overlap each other.

The line sensor may be used to detect stimulated light which is emitted from a stimulable phosphor sheet upon stimulation by stimulating light and represents a radiation image recorded on the stimulable phosphor sheet.

In the method, the line sensor may output in sequence a plurality of pieces of image data generated by the photo-sensors forming the line sensor, calibration data for calibrating the image data values output from photo-sensors which receive the stimulated light emitted from the stimulable phosphor sheet to be proportional to the amount of radiation which has entered the stimulable phosphor sheet may be made by the use of the image data for calibration output in the latter part out of a plurality of pieces of the image data output in sequence, and each image data output from the line sensors may be calibrated by the use of the calibration data thus made.

In accordance with the present invention, there is further provided a first image data correcting system comprising

a line sensor group formed by a plurality of line sensors arranged in a first direction each of which is formed by a number of photo-sensors arranged in the first direction,

a line sensor designating means which determines one of the plurality of line sensors as a reference line sensor, and determines another line sensor adjacent to the reference line sensor as an object line sensor to be corrected,

a first correction value obtaining means which obtains a first correction value for correcting first object image data to be corrected so that the first object image data value output from a first object photo-sensor in the end portion of the object line sensor facing the reference line sensor conforms to first reference image data value output from first reference photo-sensor in the reference line sensor nearer to an end of the reference line sensor facing the object line sensor,

a third correction value obtaining means which obtains a third object correction value which is for correcting the third object image data value to be corrected and not larger than the first correction value, the third image data value to be corrected being output from a third object photo-sensor remoter from a second photo-sensor which is in an end portion of the reference line sensor opposite to the object line sensor than the first object photo-sensor, and

a correcting means which corrects the first object image data value by the use of the first correction value and the third object image data value by the use of the third correction value.

In accordance with the present invention, there is further provided a second image data correcting system comprising

a line sensor group formed by a plurality of line sensors arranged in a first direction each of which is formed by a number of photo-sensors arranged in the first direction,

a line sensor designating means which determines one of the plurality of line sensors as a reference line sensor, and determines another line sensor adjacent to the reference line sensor as an object line sensor to be corrected,

a first correction value obtaining means which obtains a first correction value for correcting first object image data value to be corrected so that the average of first object image data values output from a plurality of first object photo-sensors in an end portion of the object line sensor facing the reference line sensor conforms to the average of first reference image data values output from first reference photo-sensors in the reference line sensor nearer to an end of the object line sensor facing the reference line sensor,

a third correction value obtaining means which obtains a third object correction value which is for correcting the third object image data value to be corrected and not larger than the first correction value, the third object image data value to be corrected being output from third object photo-sensors remoter from second reference photo-sensors which are in the end portion of the reference line sensor opposite to the object line sensor than the first object photo-sensors, and

a correcting means which corrects the first object image data values by the use of the first correction value and the third object image data values by the use of the third correction value.

The first correction value obtaining means may obtain the first correction value on the basis of the difference between the first reference image data value and the first object image data value.

The first correction value obtaining means may obtain the first correction value on the basis of the ratio of the first reference image data value to the first object image data value.

The first correction value obtaining means may obtain the first correction value on the basis of the difference between the first reference image data value and the first object image data value when the first reference image data value is small while obtains the first correction value on the basis of the ratio of the first reference image data value to the first object image data value when the first reference image data value is large.

The third correction value obtaining means may obtain the third correction value to hold unchanged before and after the correction a representative value of second object image data output from the second object photo-sensor in the object line sensor which are disposed in an end portion of the object line sensor opposite to the reference line sensor.

The second object photo-sensor may be a photo-sensor disposed in an end portion of the object line sensor opposite to the reference line sensor nearest to an end.

The second object photo sensor may comprise a plurality of photo-sensors while the representative value of second object image data is an average of second image data values output from the plurality of photo-sensors or one of the second image data values.

The third correction value obtaining means may obtain the third correction value to give a smaller correction value as an image data output from a photo-sensor remoter from the second reference photo-sensor.

The first and second image data correcting systems may be further provided with a control means when the line sensor group comprises three or more line sensors and the control means causes the correcting means to execute the correction after the correction by the correcting means is executed and causes the line sensor designating means to designate a line sensor which has been the object line sensor as a new reference line sensor and a line sensor which has been different from the previous reference line sensor and is adjacent to the new reference line sensor as a new object line sensor.

In the first and second image data correcting systems, the line sensor may be used to detect stimulated light which is emitted from a stimulable phosphor sheet upon stimulation by stimulating light and represents a radiation image recorded on the stimulable phosphor sheet and the line sensor may be provided with a calibrating means for calibrating the image data values output from photo-sensors which receive the stimulated light emitted from the stimulable phosphor sheet to be proportional to the amount of radiation which has entered the stimulable phosphor sheet.

In this case, the line sensor may output in sequence image data generated by photo-sensors forming the line sensor, and the calibrating means may calibrate the image data by the use of the data for calibration made by the use of the image data for calibration output in the latter part out of a plurality of pieces of the image data output in sequence.

The X-ray examining system of the present invention may be provided with the first or second image data correcting system to execute X-ray examination. The X-ray examining system may be a radiation image read-out system which detects stimulated light which is emitted from a stimulable phosphor sheet upon stimulation by stimulating light and represents a radiation image recorded on the stimulable phosphor sheet of an object and obtains image data representing the radiation image of the object.

In accordance with the present invention, there is further provided a second method of correcting image data wherein the improvement comprises the steps of

determining one of a plurality of line sensors of a line sensor group comprising the plurality of line sensors arranged in a first direction each of which comprises a number of photo-sensors arranged in said first direction as a reference line sensor,

determining another line sensor adjacent to the reference line sensor as an object line sensor to be corrected,

obtaining a first correction value for correcting first image data to be corrected so that a first object image data value output from a first object photo-sensor in the object line sensor nearer to an end facing the reference line sensor conforms to first reference image data value output from a first reference photo-sensor in the reference line sensor nearer to an end facing the object line sensor,

obtaining a third correction value which is for correcting a third image data value to be corrected and not larger than the first correction value, the third image data value to be corrected being output from a third object photo-sensor remoter from a second reference photo-sensor which is in an end portion of the reference line sensor opposite to the object line sensor than the first object photo-sensor, and

correcting the first object image data value by the use of the first correction value and the third object image data value by the use of the third correction value.

A computer program for causing a computer to execute the method of correcting image data of the present invention comprising procedure of determining one of a plurality of line sensors of a line sensor group comprising the plurality of line sensors arranged in a first direction each of which comprises a number of photo-sensors arranged in said first direction as a reference line sensor, and determining another line sensor adjacent to the reference line sensor as an object line sensor to be corrected, procedure of obtaining a first correction value for correcting first image data to be corrected so that a first object image data value output from a first object photo-sensor in the object line sensor nearer to an end facing the reference line sensor conforms to first reference image data value output from a first reference photo-sensor in the reference line sensor nearer to an end facing the object line sensor, procedure of obtaining a third correction value which is for correcting a third image data value to be corrected and not larger than the first correction value, the third image data value to be corrected being output from a third object photo-sensor remoter from a second reference photo-sensor which is in an end portion of the reference line sensor opposite to the object line sensor than the first object photo-sensor, and procedure of correcting the first object image data value by the use of the first correction value and the third object image data value by the use of the third correction value.

The computer program may be recorded in a computer readable medium and may be installed in a computer. A skilled artisan would know that the computer readable medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

The “end (portion) of the object line sensor opposite to the reference line sensor” means the end (portion) of the object line sensor opposite to the reference line sensor. Further, the “end (portion) of the object line sensor facing the reference line sensor” means the end (portion) of the object line sensor facing the reference line sensor. The “end (portion) of the reference line sensor facing the object line sensor” means the end (portion) of the reference line sensor facing the object line sensor.

The “end portion” may be either a part having a width including a plurality of photo-sensors or a point on the part having a width including a plurality of photo-sensors. In the case where the end portion includes a plurality of photo-sensors, “the image data values output from a photo-sensor in the end portion” may be, for instance, an average of the plurality of photo-sensors in the end portion. The photo-sensor in the end portion may be a single photo-sensor nearest to an end of the line sensor or a plurality of photo-sensors nearest to an end of the line sensor or one of a plurality of photo-sensors nearest to an end of the line sensor.

“To connect between image data values” means to connect between the image data values without a step and may include the case where the image data values are connected in a folding fashion between a pair of pieces of the image data to be connected.

“To arrange line sensors in a first direction” means to arrange the line sensors in the direction in which the photo-sensors are arranged. The line sensors may be arranged in a direction perpendicular to the direction in which the photo-sensors are arranged or may be arranged without overlapping the direction perpendicular to the direction in which the photo-sensors are arranged. The line sensors may be arranged spaced from each other in a direction perpendicular to the direction in which the photo-sensors are arranged or may be arranged adjacent to each other in a direction perpendicular to the direction in which the photo-sensors are arranged.

In accordance with the first method of correcting image data of the present invention, since the correction value of the image data value output from a photo-sensor in the end portion of the object line sensor opposite to the end facing the reference line sensor is small by giving larger correction values to the image data value output from a photo-sensor in the object line sensor nearer to an end of the reference line sensor facing the object line sensor so that the image data value output from photo-sensor in the object line sensor near to the end of the reference line sensor is connected to the image data value output from photo-sensor in the reference line sensor near to the end of the object line sensor facing the reference line sensor, the influence of the correction when the image data values output from the line sensors can be less in the end portion of the object line sensor opposite to the reference line sensor than in the end portion of the object line sensor facing the reference line sensor. That is, the correction value can be less in the end portion of the object line sensor opposite to the reference line sensor than in the end of the object line sensor facing the reference line sensor, whereby accumulation of the correction values each time the line sensors are corrected can be suppressed.

When the end portions of line sensors adjacent to each other out of a plurality of the line sensors arranged in the first direction overlap each other, the photo-sensor in the overlapping area of one line sensor and the photo-sensor in the overlapping area of the other line sensor can receive light emitted from substantially the same area. Accordingly, when a correction value is obtained so that the image data value output from the photo-sensor in the overlapping area of one line sensor conforms to that output from the photo-sensor in the overlapping area of the other line sensor, a more accurate correction value can be obtained.

In accordance with the first image data correcting system, a second method of correcting image data, and the computer program of the present invention, since a first correction value obtaining means which obtains a first correction value for correcting first object image data to be corrected so that the first object image data value output from a first object photo-sensor in the object line sensor conforms to a first reference image data value output from a first reference photo-sensor in the reference line sensor nearer to an end of the object line sensor facing the object line sensor, a third correction value obtaining means which obtains a third correction value which is for correcting a third object image data value to be corrected and not larger than the first correction value, the third object image data value to be corrected being output from a third object photo-sensor remoter from a second photo-sensor which is in an end portion of the reference line sensor opposite to the object line sensor than the first object photo-sensor, and a correcting means which corrects the first object image data value by the use of the first correction value and the third object image data value by the use of the third correction value are provided, the correction value of the third object image data value output from the third object photo-sensor of the object line sensor can be less than the correction value of the first object image data value output from the first object photo-sensor of the object line sensor, whereby accumulation of the correction values each time the image data from the line sensors are corrected can be suppressed.

In accordance the second image data correcting system of the present invention, since a first correction value obtaining means which obtains a first correction value for correcting first object image data value to be corrected so that the average of first object image data values output from the first object photo-sensors conforms to the average of first reference image data values output from a plurality of first reference photo-sensors, a third correction value obtaining means which obtains a third object correction value which is for correcting the third object image data value to be corrected output from third object photo-sensors and not larger than the first correction value, and a correcting means which corrects the first object image data values by the use of the first correction value and the third object image data values by the use of the third correction value are provided, the correction value of the third object image data value output from the third object photo-sensor of the object line sensor can be less than the correction value of the first object image data value output from the first object photo-sensor of the object line sensor, whereby accumulation of the correction values each time the image data from the line sensors are corrected can be suppressed.

### BRIEF DESCRIPTION OF THE DRAWINGS

FIG. 1 is a perspective view showing in brief an arrangement of a radiation image read-out system to which a method of correcting image data in accordance with an embodiment of the present invention is applied,

FIG. 2 is a view showing a plurality of line sensors arranged without overlap,

FIG. 3 is a view showing the image data value output from each photo-sensor when the photo-sensor receives light,

FIG. 4 is a view showing correction of the image data value output from a line sensor,

FIG. 5 is a perspective view showing a modification of the radiation image read-out system to which the method of correcting image data is applied,

FIG. 6 is a view showing the stepped block employed for making a lookup table which is calibration data,

FIG. 7 is a view showing the relation between the amount of radiation recorded in the stimulable phosphor sheet and the image data value output from the photo-sensor which has received the stimulated light emitted from the recorded area,

FIG. 8 is a view showing the relation between the temperature of the stimulable phosphor sheet and the change of the temperature characteristics of the stimulable phosphor sheet,

FIG. 9 is a block diagram showing the process of shading correction,

FIG. 10A is a view showing an image obtained without grid removal correction nor point defect correction,

FIG. 10B is a view showing an image obtained with only a grid removal correction effected without point defect correction,

FIG. 10C is a view showing an image obtained by effecting a point defect correction after a grid removal correction,

FIG. 11A is a view showing an image obtained without grid removal correction nor point defect correction,

FIG. 11B is a view showing an image obtained with only a point defect correction effected without grid removal correction,

FIG. 11C is a view showing an image obtained by effecting a grid removal correction after a point defect correction,

FIG. 12 is a view showing a state where a plurality of line sensors are arranged overlapping each other,

FIG. 13 is a view showing correction of the image data value output from a line sensor arranged overlapping each other,

FIG. 14 is a view showing a conventional system for correcting an image data value, and

FIG. 15 is a view showing a case where the conventional system for correcting an image data value is applied to receipt of weak light.

### DESCRIPTION OF THE PREFERRED EMBODIMENTS

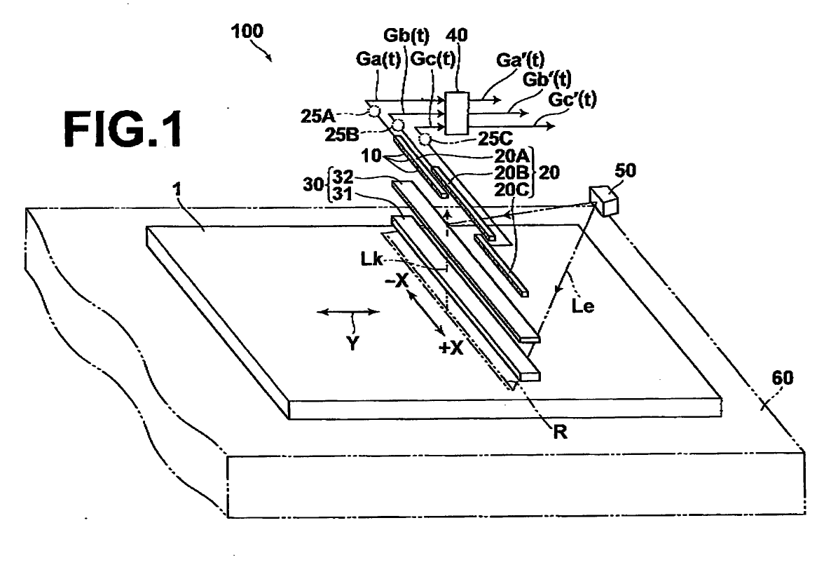

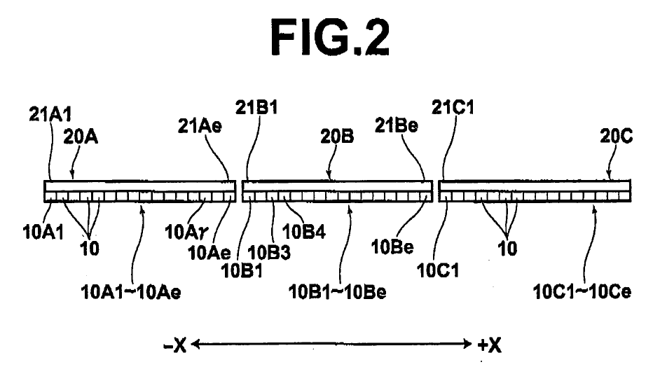

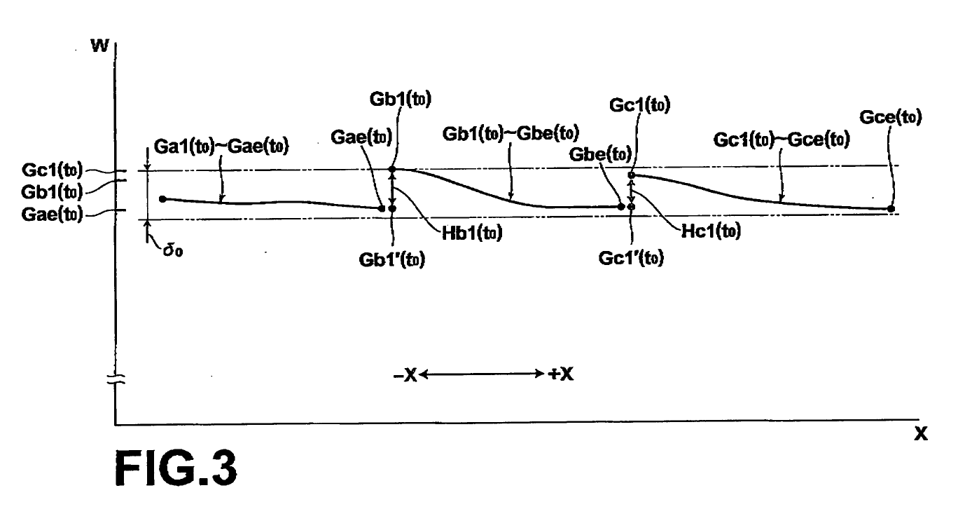

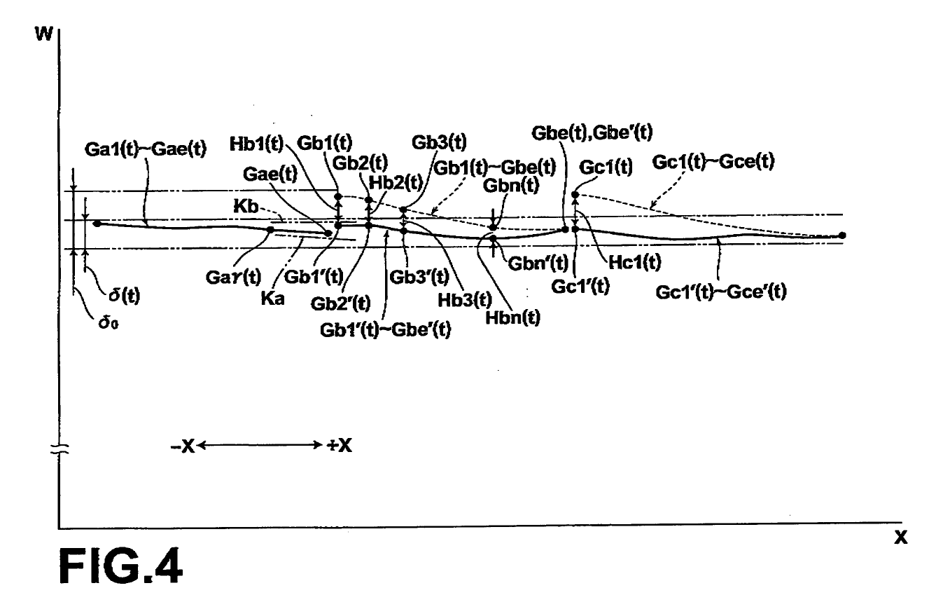

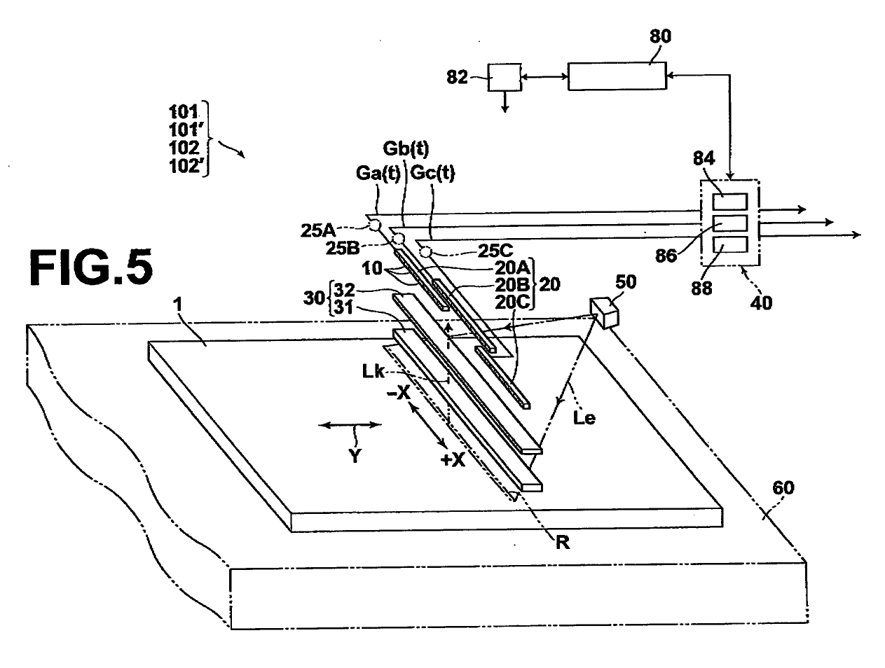

Preferred embodiments of the present invention will be described with reference to the drawings, hereinbelow. FIG. 1 is a perspective view showing in brief an arrangement of a radiation image read-out system to which a method of correcting image data in accordance with an embodiment of the present invention is applied, FIG. 2 is a view showing a plurality of line sensors arranged without overlap, FIG. 3 is a view showing the image data value output from each photo-sensor, FIG. 4 is a view showing correction of the image data value, and FIG. 5 is a perspective view showing a modification of the radiation image read-out system to which the method of correcting image data is applied. In FIGS. 3 and 4, the abscissa X represents the position of photo-sensors forming the line sensor, and the ordinate W represents the image data value output from the photo-sensor in correspondence to the position of each of the photo-sensors. In FIGS. 3 and 4, the direction toward the line sensor 20C from the line sensor 20A is the +X-direction and the direction toward the line sensor 20A from the line sensor 20C is the −X-direction.

The radiation image read-out system 100 to which the method of correcting image data in accordance with the embodiment of the present invention is applied corrects an image data value output from each photo-sensor of a plurality of line sensors 20A, 20B and 20C each of which comprises a number of photo-sensors 10 arranged in one direction (in the direction of arrow X) which is the first direction and which are arranged in said one direction.

The line sensors 20A, 20B and 20C have been corrected on their larger light amount side in their light receiving range so that they conform to each other in their light receiving characteristics. In this embodiment, the above method of correcting image data is applied to correct the image data output from a photo-sensor when receiving weak light which is on a relatively small side within the light receiving range of the photo-sensor.

However, not limited to correct the image data value output from a photo-sensor when receiving weak light which is on a relatively small side within the light receiving range of the photo-sensor, the above method of correcting image data may be applied to correct the image data value output from a photo-sensor irrespective of the amount of light which the photo-sensor receives.

In the above method of correcting image data, one of a plurality of the line sensors 20, for instance, the line sensor 20A, is determined to be a reference line sensor and the line sensor 20B, which is adjacent to the line sensor 20A determined to be a reference line sensor, is determined to be an object line sensor.

So that an image data value Gb1 output from a photo-sensor 10B1 of an end portion 21B1 facing the reference line sensor 20A conforms to an image data value Gae output from a photo-sensor 10Ae in an end portion 21Ae of the reference line sensor 20A facing the object line sensor 20B with the image data value Gbe output from a photo-sensor 10Be in an end portion 21Be of the object line sensor 20B opposite to the reference line sensor 20A fixed, image data values Gb1 to Gbe output from the photo-sensors 10B1 to 10Be forming the object line sensor 20B are corrected to give larger correction values to the image data value output from a photo-sensor in the object line sensor 20B nearer to the reference line sensor 20A.

That is, a larger correction value is given to an image data value output from a photo-sensor in the object line sensor 20B nearer to the end portion 21B1 facing the reference line sensor 20A to correct the image data values Gb1 to Gbe of the object line sensor 20B so that the image data values Gb1 to Gbe output from the photo-sensors 10B1 to 10Be in the object line sensor 20B are connected to the image data values Ga1 to Gae output from the photo-sensors 10A1 to 10Ae in the reference line sensor 20A.

A correction of the image data values Gb1 to Gbe output from the photo-sensors 10B1 to 10Be will be described with reference to FIGS. 3 and 4, here.

As shown in FIG. 3, at time t0 when the photo-sensors forming the line sensors 20A, 20B and 20C are receiving a predetermined amount of light, the image data values Gb1(t0) to Gbe(t0) output from the photo-sensors 10B1 to 10Be forming the object line sensor 20B are largest in the image data value Gb1 (t0) output from the photo-sensor in the end portion of the −X-direction and the image data value output from a photo-sensor becomes smaller as the photo-sensor is toward the +X-direction. That is, the image data value is simply reduced toward the +X-direction and is minimized to Gbe1(t0) output from the photo-sensor in the end portion of the +X-direction.

The photo-sensors in the end portions of any of the line sensors 20A, 20B and 20C are positioned not to overlap another photo-sensor. That is, in the direction in which the line sensors 20A, 20B and 20C are arranged or in the direction perpendicular to the X-direction in which the photo-sensors are arranged in each of the line sensors 20A, 20B and 20C, the photo-sensors in the line sensors 20A, 20B and 20C are positioned not to overlap another photo-sensor. Further, the width of fluctuation which is the difference between the maximum and the minimum of the image data value output from the photo-sensors forming the line sensors 20A, 20B and 20C is δ0.

The correction value Hb1(t0) of the image data value to conform the image data value Gb1(t0) output from the photo-sensor 10B1 forming the object line sensor 20B to the image data value Gae (t0) output from the photo-sensor 10Ae forming the reference line sensor 20A at the time t0 can be represented by formula
Hb1(t0)=Gb1(t0)−Gae(t0).

The proportion Rb1 (t0) of the correction value Hb1 (t0) to the image data value Gb1 (t0) is represented by the following formula. The proportion will be referred to as “the correction proportion”, hereinbelow.
Rb1(t0)=((Gb1(t0)−Gae(t0))/Gb1(t0))

Accordingly, the correction value can be represented by formula Hb1(t0)=Gb1(t0)×Rb1(t0).

Since the photo-sensor 10B1 forming the object line sensor 20B and the photo-sensor 10Ae of the reference line sensor 20A are adjacent to each other, the image data value output from the photo-sensor 10B1 and the image data value output from the photo-sensor 10Ae receive light from substantially the same area. Accordingly, when an arbitrary amount of light impinges upon the line sensors 20A, 20B and 20C instead of a predetermined amount of light, the amount of light received by the photo-sensor 10B1 substantially conforms to the amount of light received by the photo-sensor 10Ae and the image data value output from the photo-sensor 10B1 and the image data value output from the photo-sensor 10Ae substantially conform to each other.

The correction value Hb1 (t) of the image data value to conform the image data value Gb1 (t) output from the photo-sensor 10B1 forming the object line sensor 20B to the image data value Gae(t) output from the photo-sensor 10Ae forming the reference line sensor 20A at the time t when the photo-sensors forming the line sensors 20A, 20B and 20C are receiving arbitrary light can be represented by formula Hb1(t)=Gb1(t)−Gae(t).

The of the correction value Hb1(t) to the image data value Gb1(t) is represented by the following formula. The proportion will be referred to as “the correction proportion”, hereinbelow.
Rb1(t)=((Gb1(t)−Gae(t))/Gb1(t))

Accordingly, the correction value can be represented by formula Hb1(t)=U1(Gb1(t)×Rb1(t)).

Here the U1 is a coefficient and U1=1.

By subtracting the correction value Hb1(t) from the image data value Gb1 (t), the corrected image data value Gb1′ (t) can be obtained as follows.
Gb1′(t)=Gb1(t)−Hb1(t)

The relation of Gb1′ (t)=(Gb1(t)−Hb1(t))=Gae(t) is satisfied, here.

Further, as for image data values Gb2 (t) to Gbe (t) output from the photo-sensors 10B2 to 10Be forming the object line sensors 20B other than the photo-sensor 10B1, a larger correction value is given to an image data value output from a photo-sensor in the object line sensor 20B nearer to the end portion 21B1 with the image data value Gbe(t) output from a photo-sensor 10Be of the object line sensor 20B fixed.

That is, the correction value Hb2 (t) for the image data value Gbe(t) output from a photo-sensor 10B2 is set to a value smaller than the correction value Hb1(t) for the image data value Gb1(t) output from a photo-sensor 10B1.

For example, when the correction proportion Rb1 (t) which has been obtained is used,
Hb2(t)=U2×(Gb2(t)×Rb2(t)) wherein U2<U1

The correction value Hb2(t) can be obtained from the above formula. Accordingly, the corrected image data value Gb2′ (t) obtained by correcting the corrected image data value Gb2(t) can be obtained from the following formula.
Gb2′(t)=Gb2(t)−Hb2(t)
The correction value Hb3 (t) for the image data value Gb3 (t) output from a photo-sensor 10B3 can be obtained on the basis of the formula
Hb3(t)=U3×(Gb3(t)×Rb3(t)) wherein U3<U2
and accordingly, the corrected image data value Gb3′(t) obtained by correcting the corrected image data value Gb3 (t) can be obtained from the following formula.
Gb3′(t)=Gb3(t)−Hb3(t)

Similarly, the corrected image data value Gbn′(t) obtained by correcting the corrected image data value Gbn(t) can be obtained by applying the following formula to the integers n=2 to e.
Hbn(t)=Un×(Gb1(t)×Rb1(t0)) wherein Un<U(n−1) and
Gbn′(t)=Gbn(t)−Hbn(t)

The relation between the coefficients Un and U(n−1) may be partially Un=U (n−1). For example, the values from the coefficients U1 to Ue may be determined to be a function F(n) of the n which is 1 when n=1, and 0 when n=e. The function F(n) may be, for instance, a hyperbolic function or a logarithm. Specifically, the function F(n) may be determined on the basis of formula, F(n)=1−(n−1)/(e−1). From the above formula, the value U1 can be obtained by F(1)=1 and U1=1. Further, the value Ue can be obtained by F(e)=0 and Ue=0.

<<Modification of the Correction>>

Description on the time t at which the image data is output will be abbreviated in the following description. That is, the Gb1(t) will be abbreviated to Gb1.

Though the coefficient Ue=0 in the above correction, the coefficient Ue need not be Ue=0 but may be corrected so that the coefficient Ue<0 (e.g., Ue=0.1).

Though an example where the correction is made so that the image data value Gb1 and the image data value Gae are completely conform to each other has been described above, the correction need not be made so that the image data value Gb1 and the image data value Gae are completely conform to each other has been described above but there may be a difference between the image data value Gb1 and the image data value Gae in substantially the same level as the noise included therebetween.

Further, the correction value Hb1 for correcting the image data value Gb1 output from the photo-sensor 10B1 forming the object line sensor 20B to conform to the image data value Gae output from the photo-sensor 10Ae forming the reference line sensor 20A may be obtained on the basis of the ratio of the image data value Gb1 and the image data value Gae. That is, Hb1 may be equal to Gae/Gb1.

Further, when the image data value Gae output from the photo-sensor 10Ae forming the reference line sensor 20A is small, the correction value Hb1 for the image data value may be obtained from the difference between the image data value Gae and the image data value Gb1, that is from the formula Hb1 (t)=Gb1 (t)−Gae (t) while when the image data value Gae output from the photo-sensor 10Ae forming the reference line sensor 20A is large, the correction value Hb1 for the image data value is obtained from the ratio of the image data value Gb1 and the image data value Gae, that is, from the formula Hb1(t)=Gae(t)/Gb1(t).

As the photo-sensors when the image data value Gb1 output from the photo-sensor in the end portion 21B1 of the object line sensor 20B facing the reference line sensor 20A is caused to conform to the image data value Gae output from the photo-sensor in the end portion 21Ae of the reference line sensor 20A facing the object line sensor 20B, a photo-sensor 10B1 disposed nearest to the edge in the object line sensor 20B and a photo-sensor 10Ae disposed nearest to the edge in the reference line sensor 20A are employed. However, the photo-sensors need not be such photo-sensors.

For example, the image data value output from a plurality of the photo-sensors 10B1 to 10B3 in the end portion 21B1 of the object line sensor 20B facing the reference line sensor 20A may be caused to conform to the image data value output from a plurality of the photo-sensors 10Aγ to 10Ae (γ=e−3) in the end portion 21Ae of the reference line sensor 20A facing the object line sensor 20B. In this case, the image data value output from each of the photo-sensors forming the object line sensor 20B is corrected so that the average of the plurality of the image data values output from the above photo-sensors 10B1 to 10B3 conforms to the average of the plurality of the image data values output from the above photo-sensors 11A γ to 10Ae.

In the above correction, it is preferred that when the image data output from the object line sensor 20B is corrected with the image data values Gb γ′ to Gbe output from a plurality of the photo-sensors 10B γ′ to 10Be (e.g., γ=e−7) fixed, the above correction be performed not to change the representative value of the image data values, e.g., the average of the image data values.

Further, when the correction is made, the image data value Gb1 to Gbe output from the photo-sensors 10B1 to 10Be forming the object line senor 20B are corrected so that a larger correction value is given to the image data output from a photo-sensor nearer to the reference line sensor 20A out of the photo-sensors 10B forming the object line senor 20B. However, the correction value may be given to the photo-sensors in other manners.

For example, the image data value Gb1 to Gbe output from the photo-sensors 10B1 to 10Be forming the object line senor 20B may be corrected so that a correction value not larger or smaller than the correction value given to the image data value Gb1 output from the photo-sensor 10B1 in the end portion 21B1 of the object line sensor 20B facing the reference line sensor 20A is simply given to the image data values Gb2 to Gbe output from the photo-sensors 10B2 to 10Be other than the photo-sensor 10B1 in the end portion 21B1 of the object line sensor 20B facing the reference line sensor 20A.

That is, for example, when the correction value given to the image data value Gb1 is represented by Hp1 and the correction values given to the image data values Gb2 to Gbe are represented by Hp2, Hp3 . . . , the relation between the correction values Hp2, Hp3 . . . may be any so long as the correction values Hp2, Hp3 . . . are not larger or smaller than the correction value Hp1.

<<Fixing the Image Data Value>>

In the embodiment described above, a larger correction value is given to the image data output from a photo-sensor nearer to the reference line sensor out of the photo-sensors forming the object line senor so that the image data value output from the photo-sensor of the end portion of the object line sensor facing the reference line sensor conforms to an image data value output from the photo-sensor in an end portion of the reference line sensor facing the object line sensor with the image data value output from a photo-sensor in an end portion of the object line sensor opposite to the reference line sensor fixed.

However, the image data value output from a photo-sensor in an end portion of the object line sensor opposite to the reference line sensor need not be fixed. For example, a larger correction value may be given to the image data output from a photo-sensor nearer to the reference line sensor out of the photo-sensors forming the object line senor so that the image data value output from the photo-sensor of the end portion of the object line sensor facing the reference line sensor is simply connected to an image data value output from the photo-sensor in an end portion of the reference line sensor facing the object line sensor.

<<Image Data Correcting System 101>>

Image data correcting system 101 which is a modification of the image data correcting system 100 having an arrangement already described above will be described with reference to FIG. 5 and the like, hereinbelow. The elements analogous to those in the above image data correcting system 100 are given the same reference numerals and will not be described.

As shown in FIG. 5, the image data correcting system 101 comprises a line sensor group formed by a plurality of line sensors 20A, 20B and 20C arranged in a first direction (said one direction) each of which is formed by a number of photo-sensors 10 arranged in the first direction, a line sensor designating portion 82 which determines one 20A of the line sensor group as a reference line sensor, and determines another line sensor 20B adjacent to the reference line sensor 20A as an object line sensor to be corrected, a first correction value obtaining portion 86 which obtains a first correction value Hb1 for giving to a first object image data value Gb1 to be corrected so that the first object image data value Gb1 output from a first object photo-sensor 10B1 in the end portion 21B1 of the object line sensor 20B facing the reference line sensor 20A conforms to first reference image data value Gae output from first reference photo-sensor 10Ae in the reference line sensor 20A nearer to an end 21Ae of the reference line sensor 20A facing the object line sensor 20B, a third correction value obtaining portion 88 which obtains third object correction values Hb2 to Hbe which are for correcting the third object image data value Gb2 to Gbe to be corrected and not larger than the first correction value Hb1, the third image data value Gb2 to Gbe to be corrected being output from a third object photo-sensor 10B2 to 10Be remoter from a second photo-sensor 10A1 which is in an end portion 21A1 of the reference line sensor 20A opposite to the object line sensor 20B than the first object photo-sensor 10B1, and a correction value giving portion 84 which gives the first correction value to the first object image data value and the third correction value to the third object image data value, and connects the corrected image data values Gb1′ to Gbe′, the image data values Gb1 to Gbe which have been output from the object line sensor 20B and have been corrected, to the image data values Ga1 to Gae. The first correction value obtaining portion 86, the third correction value obtaining portion 88, the correction value giving portion 84 and the like form a correcting portion 40′.

The line sensor group comprises a plurality of line sensors arranged in the first direction and each line sensor comprises a number of photo-sensors arranged in the first direction.

<<Image Data Correcting System 102>>

Image data correcting system 102 which is another modification of the image data correcting system 100 having an arrangement already described above will be described with reference to FIG. 5 and the like, hereinbelow. The elements analogous to those in the above image data correcting system 100 are given the same reference numerals and will not be described.

As shown in FIG. 5, the image data correcting system 102 comprises a line sensor group formed by a plurality of line sensors 20A, 20B and 20C arranged in a first direction (said one direction) each of which is formed by a number of photo-sensors 10 arranged in the first direction, a line sensor designating portion 82 which determines one 20A of the line sensor group as a reference line sensor, and determines another line sensor 20B adjacent to the reference line sensor 20A as an object line sensor to be corrected, a first correction value obtaining portion 86 which obtains first correction values Hb1 to Hb5 (Hb1=Hb2=Hb3, sometimes simply referred to as “Hvb”, hereinbelow) for giving to first object image data values Gb1 to Gb3 to be corrected so that the average Avb of the first object image data values Gb1 to Gb3 output from a plurality of first object photo-sensors 10B1 to 10B3 in the end portion 21B1 of the object line sensor 20B facing the reference line sensor 20A conforms to the average of first reference image data values Gay to Gae output from first reference photo-sensors 10Aγ to 10Ae in the reference line sensor 20A nearer to an end 21Ae of the reference line sensor 20A facing the object line sensor 20B, a third correction value obtaining portion 88 which obtains third object correction values Hb4 to Hbe which are for correcting the third object image data values Gb4 to Gbe to be corrected and not larger than the first correction value Hvb, the third image data values Gb4 to Gbe to be corrected being output from third object photo-sensors 10B4 to 10Be remoter from a second photo-sensor 10A1 which is in an end portion 21A1 of the reference line sensor 20A opposite to the object line sensor 20B than the first object photo-sensor 10B1, and a correction value giving portion 84 which gives the first correction value Hvb to the first object image data values Gb1 to Gb3 and the third correction values Hb4 to Hbe to the third image data values Gb4 to Gbe, and connects the corrected image data values Gb1′ to Gbe′, the image data values Gb1 to Gbe which have been output from the object line sensor 20B and have been corrected, to the image data values Ga1 to Gae.

The third correction values may be smaller than the first correction value Hb1. In each of the above embodiments, the corrected image data values Gb′1 to Gbe′ (shown in the solid line in FIG. 4), where the image data values Gb1 to Gbe (shown in the broken line in FIG. 4) output from the photo-sensors 20B1 to 20Be forming the object line sensor 20B have been corrected, are obtained.

As can be understood from FIG. 4, by the use of the corrected image data values Gb′1 to Gbe′ thus obtained, the image data values Ga1 to Gae output from the photo-sensors forming the line sensor 20A and the image data values Gb1 to Gbe output from the photo-sensors forming the line sensor 20B can be continuously connected to each other without a step and accumulation of the correction values each time the line sensors are corrected can be suppressed. In the above case, the width of fluctuation after correction δ of the image data values output respectively from the line sensors 20A and 20B can be reduced as compared with the width of fluctuation before correction δ0 of the same.

It involves no problem if there is such a step that will be embedded in the noise included in the image data value when the image data values Ga1 to Gae are connected to the image data values Gb1 to Gbe. That is, the system of connecting the image data values Ga1 to Gae and the image data values Gb1 to Gbe continuously to each other without a step need not be limited to the case where the image data values Ga1 and Gb1 completely conform to each other.

Further, when the image data is displayed as a visible image, an area of the image A displayed by the image data output from the photo-sensors forming the line sensor 20A and an area of the image B displayed by the image data output from the photo-sensors forming the line sensor 20B can be smoothly connected to each other so that the image density is not discontinuous at the border therebetween since the image data values Ga1 to Gae output from the line sensor 20A and the image data values Gb1 to Gbe output from the line sensor 20B are connected to each other.

As described above, the correction where the image data values Gb1 to Gbe are connected to the image data values Ga1 to Gae has only to be made so that the image density is not discontinuous at the border between the area of the image A displayed by the image data output from the line sensor 20A and an area of the image B displayed by the image data output from the line sensor 20B. That is, the correction may be made without completely conforming the image data values which are included in the image A and represents the vicinity of the border to the image data values which are included in the image B and represents the vicinity of the border so long as the image density is not discontinuous at the border between the image A and the image B.

For example, the correction may be even if an image data values Gae adjacent to the border between the image A and the image B is somewhat different from the corrected image data value Gb1′ or the inclination Ka of the straight line which linearly approximates each image data value representing the vicinity of the border in the image A on a coordinate system (the coordinate system of FIG. 4) where the ordinate represents the image data value and the abscissa represents the position of the photo-sensors outputting a plurality of pieces of the image data along the direction in which the photo-sensors are arranged, differs from the inclination Kb of the straight line which linearly approximates each image data value representing the vicinity of the border in the image B on the coordinate system as shown in FIG. 4 so long as the image density is not discontinuous at the border between the image A and the image B.

<<Change of the Object Line Sensor:(1)>>

The relation between the line sensor which is a reference line sensor and the line sensor which is an object line sensor is changed and the image data values output from the line sensor 20 are corrected next. That is, the line sensor 20B which has been the object line sensor is determined to be the reference line sensor with the line sensor 20C adjacent to the line sensor 20B determined to be the object line sensor and the same technique can be applied to correct image data values Gc1 to Gce output from the photo-sensors 10C forming the line sensor 20C into the corrected image data values Gc1′ to Gce′.

More specifically, the following action may be executed by causing the correcting portion 40 provided in the image data correcting system to execute the correction and/or causing the control means 80 for controlling the action of each parts or the timing thereof to control the line sensor designating portion 82. That is, after determining one of the line sensors 20A, 20B and 20C forming the line sensor group as a reference line sensor, determining another line sensor adjacent to the reference line sensor as an object line sensor to be corrected and causing, the line sensor designating portion 82 is caused to designate the preceding object line sensor as a new reference line sensor and to designate a line sensor which differs from the preceding reference line sensor and is adjacent to the new reference line sensor as a new object line sensor and the correcting portion 40 is caused to execute the correction.

<<Application of the Object Line Sensor to a Radiation Image Read-out System>>

Application of a method of and a system for correcting the image data value output from the line sensor to a radiation image read-out system which is an example of the X-ray examining system which carries out an X-ray examination will be described next.

As shown in FIGS. 1 and 5, the radiation image read-out system 100 comprises a stimulating light projecting portion 50 which projects linear stimulating light Le extending in a main scanning direction (X-direction in FIGS. 1 and 5) onto a stimulable phosphor sheet 1 on which a radiation image has been recorded, a conveying portion 60 which conveys the stimulable phosphor sheet 1 in a sub-scanning direction (direction of arrow Y in FIGS. 1 and 5) intersecting the main scanning direction, the line sensor 20 comprising a number of the photo-sensors 10 which are arranged in the main scanning direction and each of which obtains image data representing the amount of stimulated light Lk which the photo-sensor 10 receives by photoelectrically converting the stimulated light Lk emitted from the stimulable phosphor sheet 1 upon projection of the stimulating light Le, an imaging optical system 30 comprising an imaging lens 31 which comprises a number of arranged refractive index profile lenses to image light from an area R of projection of the stimulable phosphor sheet 1 onto which the stimulating light Le is projected and which extends in the main scanning direction on the photo-sensors 10, a stimulating light cut filter 32 which cuts the stimulating light and transmits the stimulated light and the like, and a correcting portion 40 to be described later.

When certain kinds of phosphors are exposed to radiation such as X-rays, they store a part of energy of the radiation. Then when the phosphors which have been exposed to the radiation are exposed to stimulating light such as visible light, light is emitted from the phosphors in proportion to the stored energy of the radiation. Phosphors exhibiting such properties are generally referred to as “stimulable phosphors”. In this specification, the light emitted from the stimulable phosphors upon stimulation thereof will be referred to as “stimulated light”. The stimulable phosphor sheet 1 is a sheet having a layer of stimulable phosphors. In the radiation image read-out system by the use of the stimulable phosphor sheet 1, a radiation image of an object such as a human body is once recorded on the stimulable phosphor sheet, a stimulating light beam Le such as a laser beam is subsequently caused to scan the stimulable phosphor sheet 1 to emit the stimulated light Lk therefrom and the stimulated light Lk is photoelectrically read out by photo-sensors 10 forming the line sensor 20 to obtain an image data representing the radiation image.

The pieces of image data output from the photo-sensors 10 forming the line sensor 20 are input into the correcting portion 40 and the correcting portion 40 outputs, when an image data value, e.g., Gbn output from the photo-sensor is input thereinto, a corrected image data value Gbn′ on the basis of the above technic.

In order to execute the above method of correcting image data, the correcting portion 40 stores therein the function F(n) and the following formula.
Gbn′=Gbn−Hbn
Gcn′=Gcn−Hcn

Operation of the radiation image read-out system 100 when reading out the radiation image recorded in the stimulable phosphor sheet 1 will be described, hereinbelow.

The stimulating light Le is projected onto the stimulable phosphor sheet 1 while the stimulable phosphor sheet 1 is conveyed in the sub-scanning direction by the conveying portion 60 and stimulated light Lk which is emitted from the stimulated light projected area R and propagates through the imaging optical system 30 and the stimulating light cut filter 32 is received by the line sensors 20A, 20B and 20C.

The photo-sensors 10A, 10B and 10C forming the line sensors 20A, 20B and 20C photoelectrically convert the stimulated light Lk and output image data representing the amount of the stimulated light Lk.

The image data values Ga1 to Gae output from the photo-sensor 10A, the image data values Gb1 to Gbe output from the photo-sensor 10B and the image data values Gcd to Gce output from the photo-sensor 10C are input into the correcting portion 40, and the correcting portion 40 outputs corrected image data values corrected on the basis of the above formula.

That is, the corrected image data values Gb1′ to Gbe′ to which the image data values Gb1 to Gbe are corrected and the corrected image data values Gc1′ to Gce′ to which the image data values Gc1 to GCe are corrected are output from the correcting portion 40. The image data values Ga1 to Gae are output from the correcting portion 40 as they are without the correction.

With this arrangement, the image data values output from photo-sensors forming a plurality of the line sensors can be connected while suppressing increase of fluctuation of the image data value output from each of the photo-sensors. When the radiation image of the object represented by pieces of the image data is displayed as a visible image, unevenness in the density between the images of areas on the stimulable phosphor sheet 1 detected by the line sensors is suppressed, and a radiation image where the areas are smoothly connected in the density can be obtained.

<<Calibration of the Line Sensors>>

In the above method, it is preferred that the image data value output from each photo-sensor be calibrated by the use of the image data for calibration obtained from a photo-sensor deviated from the center of the object line sensor toward the end of the object line sensor opposite to the reference line sensor and this case will be described, hereinbelow. It is preferred that the calibration be carried out before the correction by the correcting portion.

The calibration is executed by output calibrating portions 25A, 25B and 25c which are calibrating means. That is, when the line sensor outputs in sequence image data generated by photo-sensors forming the line sensor, the output calibrating portions 25A, 25B and 25c calibrate image data value output from the photo-sensor receiving stimulated light emitted from the stimulable phosphor sheet to be proportional to the amount of radiation impinging upon the stimulable phosphor sheet per unit area by the use of calibration data made on basis of the image data for calibration output in the latter part out of a plurality of pieces of the image data output in sequence from the line sensor.

In this particular embodiment, the output calibrating portions 25A, 25B and 25c are provided in correspondence respectively to the line sensors 20A, 20B and 20C (See FIGS. 1 and 5). Though the operation of the output calibrating portion 25B will be mainly described hereinbelow, the operation of the other output calibrating portions 25A and 25C is the same as the operation of the output calibrating portion 25B.

The output calibrating portion 25B calibrates the image data value input from each of the photo-sensors 10B1 to 10Be forming the line sensor 20B to be a value which more accurately corresponds to the radiation impinging upon the stimulable phosphor sheet 1 when an image of the object was recorded thereon, thereby obtaining a calibrated image data value and inputs the calibrated image data value into the correcting portion 40.

The output calibrating portion 25B stores therein a lookup table LTb which is the data for calibration obtained in advance and carries out the correction by the use of the lookup table LTb.

The lookup table LTb is prepared in the following manner.

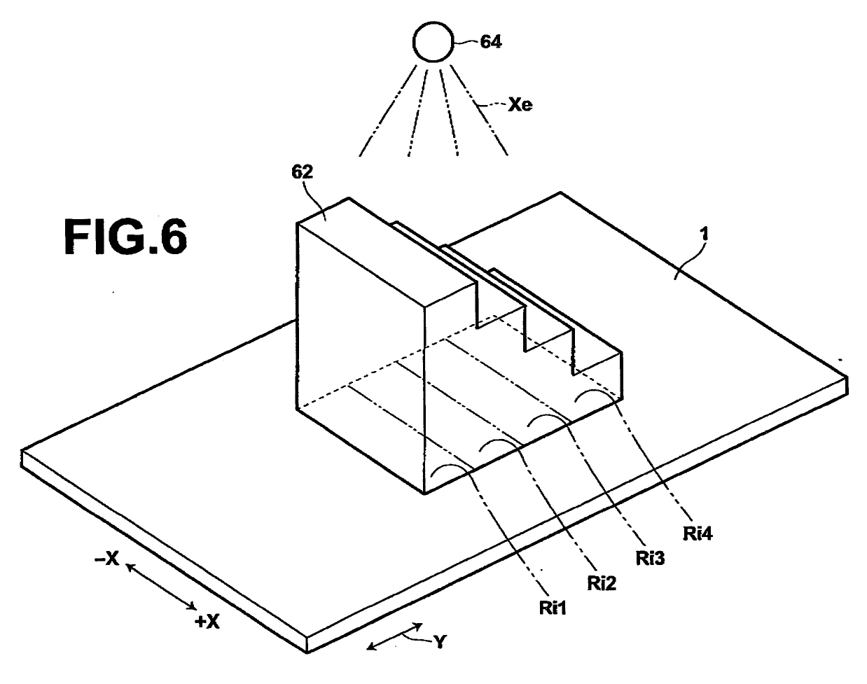

FIG. 6 shows a stepped block on the stimulable phosphor sheet 1 for preparing the data of the lookup table LTb.

As shown in FIG. 6, the stepped block 62 which is of aluminum or stainless steel and has step-like indents in a perpendicular direction (the direction of arrow Y in FIG. 6 which is the sub-scanning direction) to the longitudinal direction of the line sensor (the direction of arrow X in FIG. 6 which is the main scanning direction) is disposed on a stimulable phosphor sheet 1 erased with the radiation energy and radiation Xe is projected thereonto from a radiation source 64 above the stepped block 62.

The radiation Xe is transmitted to the stimulable phosphor sheet 1 through the stepped block 62 while radiation energy thereof is partly absorbed by the stepped block 62. Radiation Xe which has passed through the stepped block 62 and thereby attenuated in its radiation energy impinges upon the stimulable phosphor sheet 1 and is recorded thereon.

It is assumed here that the area on the stimulable phosphor sheet 1 on which the thickest part of the stepped block 62 is placed is represented by Ri1, the area on the stimulable phosphor sheet 1 on which the second thickest part of the stepped block 62 is placed is represented by Ri2, and thereafter, areas on the stimulable phosphor sheet 1 on which thicker parts of the stepped block 62 are placed is represented by Ri3 and Ri4 in this order.

Then the stimulable phosphor sheet 1 on which a radiation image representing the stepped block has been recorded is read by the radiation image read-out system 100.

While projecting the stimulating light Le onto the stimulable phosphor sheet 1 by the stimulating light projecting portion 50 and conveying the stimulable phosphor sheet 1 in the sub-scanning direction by the conveying portion 60, the line sensor 20 obtains image data value representing the amount of the stimulated light Lk which has been generated from the stimulating light projecting area R (See FIGS. 1 and 5) on the stimulable phosphor sheet 1 and received by each of the photo-sensors 10 through the imaging optical system 30.

The amount of radiation stored (recorded) in the stimulable phosphors through each of the steps of the stepped block 62 corresponds to the thickness of the step. That is, as the thickness of the step increases, the amount of radiation stored in the stimulable phosphors is reduced and as the thickness of the step reduces, the amount of radiation stored in the stimulable phosphors increases. Accordingly, the image data value read out from the stimulable phosphor sheet 1 and representing the radiation image of each step of the stepped block 62 should ideally correspond to the thickness of the part.

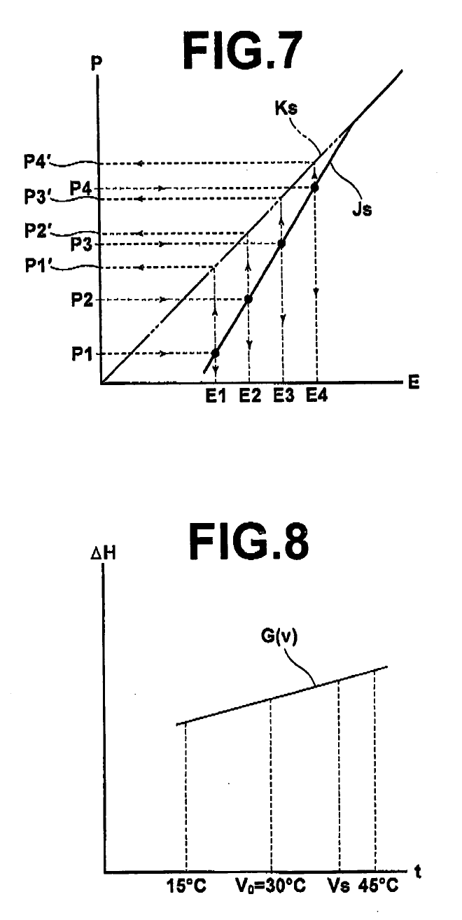

FIG. 7 shows the relation between the amount of radiation impinging upon the stimulable phosphor sheet 1 per unit area thereof and the image data value output from a photo-sensor receiving the stimulated light emitted from the area stored therein the amount of radiation. In FIG. 7, the ordinate P represents the image data value output from the photo-sensor and the abscissa E represents the amount of radiation impinging upon the stimulable phosphor sheet 1 per unit area thereof. The ordinate P and the abscissa E are in logarithmic values.

In FIG. 7, the amounts of radiation stored per unit area in the areas Ri1, Ri2, Ri3 and Ri4 on the stimulable phosphor sheet 1 are respectively denoted by E1, E2, E3 and E4. The representative values, e.g., the averages, of the image data values for calibration output from a plurality of the photo-sensors receiving the stimulated light emitted from the areas Ri1, Ri2, Ri3 and Ri4 on the stimulable phosphor sheet 1 are respectively denoted by P1, P2, P3 and P4.

Ideally, the image data values obtained by reading out the amounts of radiation stored therein according to the amount of radiation impinging thereupon should be in proportion to the amounts of radiation impinging the stimulable phosphor sheet 1 per unit area thereat according to the thickness of the step as shown by a straight line Ks (the two-dot chained line) on the coordinate system shown in FIG. 7.

However, sometimes the former is not in perfect proportion to the latter due to factors of convenience in production of each part or the like. In the fact, deviation from the straight line Ks of the relation between the amounts of radiation impinging the stimulable phosphor sheet 1 per unit area and the image data value output from a photo-sensor receiving the stimulated light emitted from the stimulable phosphor sheet 1 in correspondence to the amount of radiation increases as the amount of radiation read out decreases as shown, for instance, by the straight line is passing through the coordinates (E1, P1), (E2, P2), (E3, P3) and (E4, P4) in FIG. 7.

The lookup table LTB is prepared on the basis of the image data values for calibration output from the above photo-sensors, that is, on the basis of the straight line Js in FIG. 7.

For example, when the image data value output from the photo-sensor is P1, that the amount of radiation stored at the area (substantially equal to the amount of radiation impinging the area) on the stimulable phosphor sheet 1 which emits the stimulated light received by this photo-sensor is E1 is obtained from the straight line Js. Then the lookup table LTB is prepared so that the above image data value P1 is calibrated by way of straight line Ks to a value P1′ corresponding to the above amount E1 of radiation.

Similarly, when the image data value output from the photo-sensor is P2, that the amount of radiation stored at the area on the stimulable phosphor sheet 1 which emits the stimulated light received by this photo-sensor is E2 is obtained from the straight line Js. Then the lookup table LTB is prepared so that the above image data value P2 is calibrated by way of straight line Ks to a value P2′ corresponding to the above amount E2 of radiation.

That is, the lookup table LTB is prepared to convert the input image data P1 to the image data P1′ and output the image data P1′, while to convert the input image data P2 to the image data P2′ and output the image data P2′.

One kind of the lookup table LTB is made for the line sensor 20B. The image data values for calibration output from a plurality of photo-sensors employed to prepare the lookup table LTB are made by the use of the image data values obtained by the use of the photo-sensors positioned nearer to fixed end of the line sensor 20B than the center of the line sensor 20B (The middle between the fixed end and the free end to be described later). The image data values obtained by the above photo-sensors are output in the latter part out of a plurality of pieces of the image data output in sequence from the line sensor.

The fixed end of the line sensor is an end portion of the line sensor where the image data value output from the photo-sensor is fixed or the correction value for the image data value output from the photo-sensor is suppressed by the correcting potion 40. Whereas, the free end of the line sensor is an end portion of the line sensor where the image data value output from the photo-sensor disposed in the end portion of the line sensor is corrected by the correcting portion 40 to be connected to the image data value output from the photo-sensor of the fixed end of other line sensor adjacent thereto. In this particular embodiment, the fixed end is the end portion 21Be and the free end is the end portion 21B1 in the line sensor 20B. The end portion 21Be is sometimes referred to as “the fixed end 21BE” as well as “the free end 21Be, and the end portion 21B1 is sometimes referred to as “the free end 21B1” as well as “the fixed end 21B1”, hereinbelow.

In the above line sensor, generally, the operation of reading the image data output from the photo-sensors in opposite end portions is not stabilized and fluctuation in the image data values output from the above line-sensor is large. Further, there is a tendency that the pieces of image data output from the photo-sensors in the end portion where the image data is read out earlier in the line sensor are larger in fluctuation than the pieces of image data output from the photo-sensors in the end portion where the image data is read out later in the line sensor. Accordingly, it is preferred that the end portion in which the photo-sensors from which the image data values are read out earlier be the free end while the end portion in which the photo-sensors from which the image data values are read out later is the fixed end. With this arrangement, deterioration in reliability of the image data values output from the photo-sensors in the fixed end portion can be suppressed.

More specifically, it is preferred that the image data be read out first from the free end 21B1 of the object line sensor 20B where the correction value for the image data is larger while the image data is read out last from the fixed end 21Be of the object line sensor 20B where the correction value for the image data is smaller.

By calibrating the image data values output from the photo-sensors disposed in the area toward the fixed end 21Be from the middle of the line sensor 20B by the use of the image data for calibration obtained from the photo-sensor disposed in the area toward the fixed end 21Be from the middle of the line sensor 20B as described above, more accurate image data values can be obtained from the image data values output from the photo-sensors disposed in the area toward the fixed end 21Be from the middle of the line sensor 20B. With this arrangement, reliability of the image data values output from the photo-sensors in the fixed end portion 21Be through the output calibrating portion 25B can be further improved. Further, in the case where the above image data values are connected, reliability of the image data values output from the photo-sensors in the fixed end portion 21Be through the output calibrating portion 25B and the correcting portion 40 can be further improved.

Whereas the image data value output from the photo-sensor in the free end portion 21B1 of the line sensor 20B is corrected to be forced to be connected to the image data value output from the photo-sensor in the fixed end portion 21Ae of said other line sensor 20A. The pieces of the image data should originally conform to each other. Accordingly, improving the reliability of the image data value output from the photo-sensor in the fixed end portion 21Ae of the above line sensor 20A is improving the reliability of the image data value output from the photo-sensor in the free end portion 21B1 of the above line sensor 20B.

Though, the line sensor 20B, the output calibrating portion 25B and the lookup table LTb employed in the output calibrating portion 25B have been mainly described above, it is needless to say that image data values can be corrected in a similar manner by the use of the line sensor 20A, the output calibrating portion 25A and the lookup table LTa employed in the output calibrating portion 25A or the line sensor 20C, the output calibrating portion 25C and the lookup table LTc employed in the output calibrating portion 25C.

The correction of image data value need not be limited to those by the use of the lookup table, the correction of image data value may be carried out in any manner so long as image data value output from each of the photo-sensors forming the line sensor is corrected on the basis of the image data values for calibration output from the photo-sensors disposed in the area toward the fixed end from the middle of the line sensor.

In the above line sensor, generally, the operation of reading the image data output from the photo-sensors in opposite end portions is not stabilized and fluctuation in the image data values output from the above line-sensor is large. Further, there is a tendency that the pieces of image data output from the photo-sensors in the end portion where the image data is read out earlier in the line sensor are larger in fluctuation than the pieces of image data output from the photo-sensors in the end portion where the image data is read out later in the line sensor. Accordingly, it is preferred that the end portion in which the photo-sensors from which the image data values are read out earlier be the free end while the end portion in which the photo-sensors from which the image data values are read out later is the fixed end. With this arrangement, deterioration in reliability of the image data values output from the photo-sensors in the fixed end portion can be suppressed.

The image data for calibration employed in making the data for calibration may be either the hole or a part of the latter portion of the image data to be output in sequence from the line sensor. Further, it is preferred that the image data for calibration employed in making the data for calibration be a plurality of pieces of image data to be output in sequence from the line sensor minus one or more pieces of image data output last therefrom. For example, when the line sensor comprises 1000 photo-sensors, it is preferred that a plurality of pieces of image data to be output in sequence from the line sensor minus 50 pieces of image data output last therefrom be used for the image data for calibration.

<<Change of the Object Line Sensor:(2)>>

When the above correction is made on the image data values output from photo-sensors of three or more line sensors, the above correction may be made with a line sensor having an end portion the image data values in which are determined to be fixed in advance determined to be the reference line sensor and with a line sensor adjacent thereto determined to be the object line sensor.

Otherwise, after the correction is carried out for two line sensors, the corrected two line sensors are regarded to be a single object line sensor with another or the other line sensor determined to be the reference line sensor, and the above correction may be carried out again for the reference and object line sensors. Conversely, the corrected two line sensors are regarded to be a single reference line sensor with another or the other line sensor determined to be the object line sensor, and the above correction may be carried out again for the reference and object line sensors.

Further, though even if any of the line sensors is selected as the reference line sensor, the same result can be obtained, it is preferred that a line sensor outputting substantially the same image data values when a predetermined amount of light is received be selected as the reference line sensor.

The line sensors need not be limited to those for detecting stimulating light emitted from a stimulable phosphor sheet, and the photo-sensors need not be limited to those comprising a CCD.

<<Shading Correction>>

The case where shading correction is further carried out on image data representing a radiation image obtained by the radiation image read-out system 100 will be described, hereinbelow. It is preferred that the shading correction be carried out before the calibration by the output calibrating portion or the correction by the correcting portion.

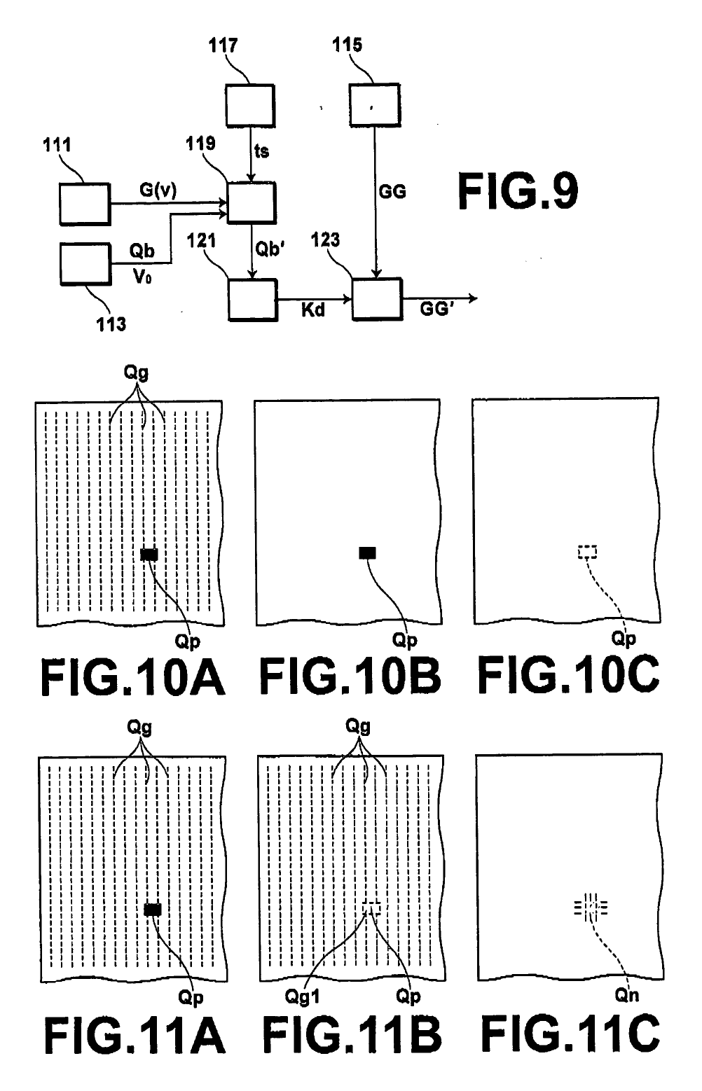

FIG. 8 is a view showing the relation between the temperature of a stimulable phosphor sheet and the change of the temperature characteristics of the stimulable phosphor sheet, and FIG. 9 is a block diagram showing the process of shading correction.

The phenomenon that unevenness is generated in an image obtained by reading out a radiation image of the object due to that the amount of radiation projected onto the object per unit area is not uniform and locally varies or the sensitivity of the line sensor for detecting stimulated light emitted from the stimulable phosphor sheet locally varies upon recording or reading of a radiation image is called “shading”.

The “shading correction” is a correction where the unevenness in density which appears in a solid image to be described later, from an image representing a radiation image of the object obtained by projecting the radiation onto the object in order to remove the unevenness in density due to influence of the shading included in the image representing a radiation image of the object.

The solid image is an image obtained by projecting the radiation onto a stimulable phosphor sheet without passing through an object and reading the stimulable phosphor sheet. Though the solid image read out from the stimulable phosphor sheet should be originally even in its density, it is in fact an image with unevenness in density due to the influence of the shading.

In recording or read-out of a radiation image on or from the stimulable phosphor sheet, the radiation absorbing efficiency of the stimulable phosphor sheet and/or the stimulated light emitting efficiency of the stimulable phosphor sheet upon stimulation by the stimulating light generally change with change in the temperature of the stimulable phosphor sheet. Accordingly, an image obtained by reading out the stimulable phosphor sheet changes in density according to the temperature of the stimulable phosphor sheet upon reading out the stimulable phosphor sheet.

Accordingly, when there is a difference between the temperature of the stimulable phosphor sheet upon obtainment of the solid image to be stored in advance and the temperature of the stimulable phosphor sheet upon reading out a radiation image of the object, the influence of shading corresponding to the difference in temperature will remain in an image representing a radiation image of the object.

On the other hand, it has been determined to use the radiation image read-out system in the temperature range of 15 to 45° C. in recording and reading out a radiation image. Accordingly, it is necessary to carry out the shading correction taking into account the temperature range. Further, in the temperature range of 15 to 45° C. where the radiation image read-out system is actually employed, the change ΔH with temperature of the radiation absorbing efficiency and the stimulated light emitting efficiency of the stimulable phosphor sheet (will be referred to as “the change ΔH with temperature of the temperature characteristics of the stimulable phosphor sheet”, hereinbelow.) can be approximated by a simple function G(v). (See FIG. 8)

Accordingly, corrected object image data GG′ more accurately representing a radiation image can be obtained by, while solid image data Qb is obtained by the use of a stimulable phosphor sheet held at a predetermined temperature vo in the temperature range and is stored, and the temperature vs of the stimulable phosphor sheet is measured thereby obtaining corrected solid image data Qb′, representing a solid image which should be obtained when the stimulable phosphor sheet is at the temperature vs, through the calculation by the use of the above temperature characteristics G (v), carrying out shading correction on object image data GG, obtained by actually reading out a radiation image of the object, by the use of the corrected solid image data Qb′.

More specifically, as shown in the block diagram of FIG. 9, the relation G(v) between the temperature v and the change AH of the temperature characteristics of the stimulable phosphor sheet is obtained in advance and stored in a temperature characteristic storage portion 111 and the solid image data Qb is obtained by the use of a stimulable phosphor sheet at a predetermined temperature vo and is stored in a solid image storage portion 113.

Then the recording and reading out of a radiation image of the object are carried out, and the object image data GG representing a radiation image of the object is stored in an image data storage portion 115. At the same time, the temperature vs of the stimulable phosphor sheet is measured by a temperature measuring portion 117 when the recording and reading out of a radiation image of the object are carried out.

Thereafter, a solid image correcting portion 119 inputs the solid image data Qb and the temperature vo when the solid image data Qb is obtained (e.g., vo=30° C.) from the solid image storage portion 113. At the same time, the solid image correcting portion 119 inputs the above temperature characteristics G(v) from the temperature characteristic storage portion 111 and the measured temperature vs from the temperature measuring portion 117.

Then the solid image correcting portion 119 obtains the corrected solid image data Qb′ by correcting the solid image data Qb by the use of the temperature vo, the measured temperature vs and the temperature characteristics G(v). The corrected solid image data Qb′ is an image data obtained by correcting the solid image data Qb before correction by the difference between the temperature vo and the measured temperature vs and an image data which approximates the image data which should be obtained when the stimulable phosphor sheet is at the measured temperature vs.

Then a correction coefficient obtaining portion 121 obtains correction coefficient data Kd for correcting the density of all the pixels forming the image representing the object by dividing each of the values forming the corrected solid image data Qb′, that is, the value representing the density of each of the pixels forming the corrected solid image by the average obtained by averaging all the values forming the corrected solid image data Qb′.

The a shading correction portion 123 obtains corrected object image data GG′, where shading correction taking into account the temperature characteristics of the stimulable phosphor sheet has been carried out, by multiplying the object image data GG input from the image data storage portion 115 by the correction coefficient data Kd input from the correction coefficient obtaining portion 121.

On the console screen (not shown) of the radiation image read-out system 100, is displayed a value which indicates the radiation dose (also referred to as “the S value”). When the S value is obtained, a stabilized S value can be obtained without affected by fluctuation in the temperature of the stimulable phosphor sheet upon recording or reading out the radiation image by correction by the use of similar technic.

Removal of an image representing the grid employed when a radiation image of the object is recorded and an image representing the point defect on the stimulable phosphor sheet will be described, hereinbelow. It is preferred that the removal be carried out after the above described shading correction, the correction by the correcting portion and the calibration by the output calibrating portion.

The grid is employed to suppress deterioration of the image quality due to influence by the scattered radiation when a radiation image of the object is recorded. The grid comprises, for instance, a plurality of parallel plates which are wide in the direction in which the radiation for recording the radiation image is propagated, are disposed 36 pieces per 1 cm and extends in a direction perpendicular to the direction in which the radiation for recording the radiation image is propagated. In an image of the object recorded by the use of such a grid and read out, an image representing the grid mingles. Accordingly, conventionally, there has been carried out a grid removal correction where the image of the grid is removed from the object image.

On the other hand, the point defect is a defect where, for instance, dust adhering to the stimulable phosphor sheet appears as point-like defect in an image representing the object. In order to be less remarkable for such defect, there has been, conventionally, carried out a point defect correction where the image data values representing the point defect is corrected by the use of image data surrounding the image data representing the point defect.

Here, the grid removal correction is first carried out and the point defect correction is subsequently carried out. This arrangement suppresses deterioration of the quality of an image finally obtained and representing the object as compared with when the point defect correction is first carried out and the grid removal correction is subsequently carried out.

Operation of suppressing deterioration of the quality of an image representing the object will be described. In the following description, it is assumed that the point defect has such a size that substantially extends over two adjacent grids.

FIG. 10 are views showing the state of removing the grid and the point defect when the grid removal correction is first carried out and the point defect correction is subsequently carried out. FIG. 10A is a view showing an image obtained without grid removal correction nor point defect correction, FIG. 10B is a view showing an image obtained with only a grid removal correction effected without point defect correction, and FIG. 10C is a view showing an image obtained by effecting a point defect correction after a grid removal correction. FIG. 11 are views showing the state of removing the grid and the point defect when the point defect correction is first carried out and the grid removal correction is subsequently carried out. FIG. 11A is a view showing an image obtained without grid removal correction nor point defect correction, FIG. 11B is a view showing an image obtained with only a point defect correction effected without grid removal correction, and FIG. 11C is a view showing an image obtained by effecting a grid removal correction after a point defect correction.

When the grid removal correction is first carried out and the point defect correction is subsequently carried out, the image Qp representing the point defect remains as it is, though the image Qg representing the grid can be normally removed by the grid removal correction as can be understood from comparison of FIGS. 10A and 10B. Further, when the grid removal correction is first carried out and the point defect correction is subsequently carried out, the point defect image Qp can be normally removed as can be understood from comparison of FIGS. 10B and 10C.

On the other hand, when the point defect correction is first carried out and the grid removal correction is subsequently carried out, the point defect image Qp is removed by the point defect correction and at the same time, the part Qg1 of the grid image Qg included in the point defect image Qp is removed as can be understood from comparison of FIGS. 11A and 11B. On the other hand, the grid image Qg other than the part grid image Qg1 remains as it is. Further, when the grid removal correction is carried out after the point defect correction, though the grid image Qg other than the part grid image Qg1 is normally removed, a new defect can appear in the area of the part grid image Qg1 as can be understood from comparison of FIGS. 11B and 11C.

The reason why the new defect appears is as follows.

The difference Δp between the image data value representing the point defect image Qp and the image data value representing the surrounding area of the point defect image Qp is significantly large. On the other hand, The difference Δg between the image data value representing the grid image Qg and the image data value representing the surrounding area of the grid image Qg is generally significantly small as compared with the difference Δp in the point defect image Qp. Accordingly, when the point defect correction is carried out, the part grid image Qg1 which is the part of the grid image Qg included in the area of the point defect image Qp is removed together with the point defect image Qp. When the grid removal correction which is a filter processing for removing the frequency component corresponding to the grid image Qg arranged in constant intervals is subsequently carried out, the new defect Qn is generated in the area of the part grid image Qg1 already removed with the grid image Qg and the area therearound together with the removal of the frequency component.

If the grid removal correction and the point defect correction are both carried out on image data which has been obtained by recording and reading out of a radiation image of the object, a higher quality of an image can be obtained when the grid removal correction is carried out after the point defect correction as compared with when the order is reversed, as described above.

It is preferred as described above that the grid removal correction and/or the point defect correction be carried out after the described shading correction, the correction by the correcting portion and the calibration by the output calibrating portion.

<<Correction when the Line Sensors are Arranged in Overlapping State>>

The line sensors are arranged not to overlap each other in a direction perpendicular to said one direction, the direction in which the photo-sensors are arranged in the above description. However, also in the case where the line sensors are arranged to overlap each other in a direction perpendicular to the direction in which the photo-sensors are arranged, image data can be corrected in the same manner as described above.

All the technics described above in conjunction with the case where the line sensors do not overlap each other can be also applied to the case where the line sensors overlap each other.

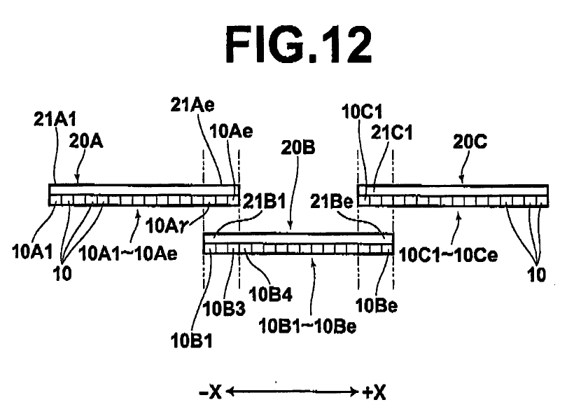

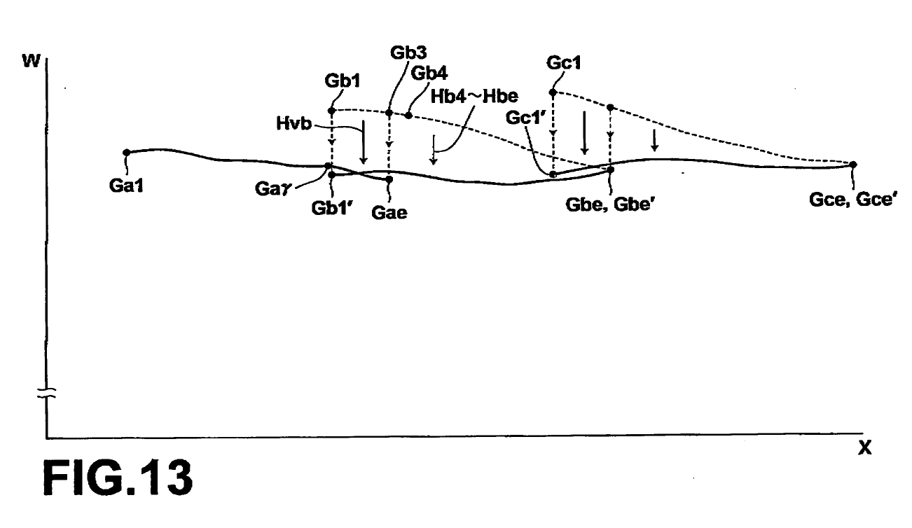

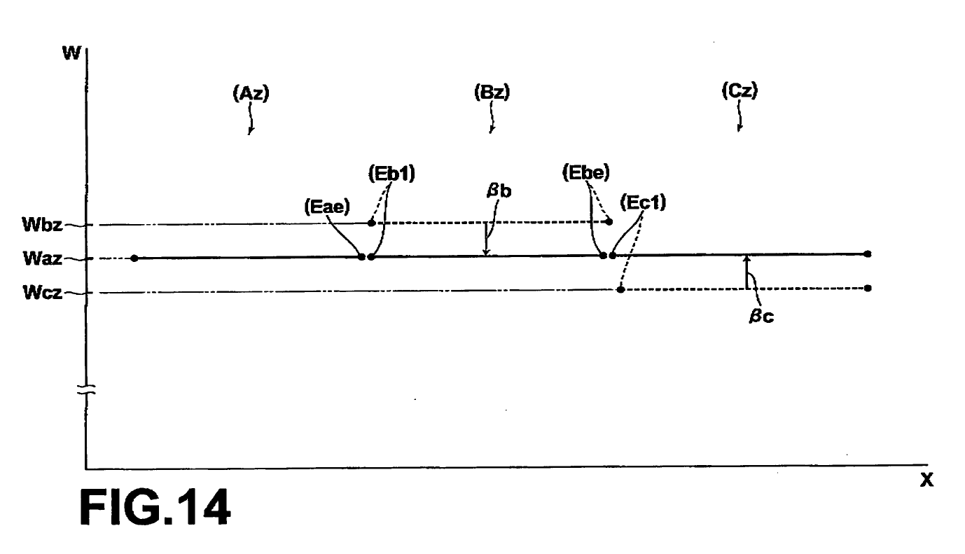

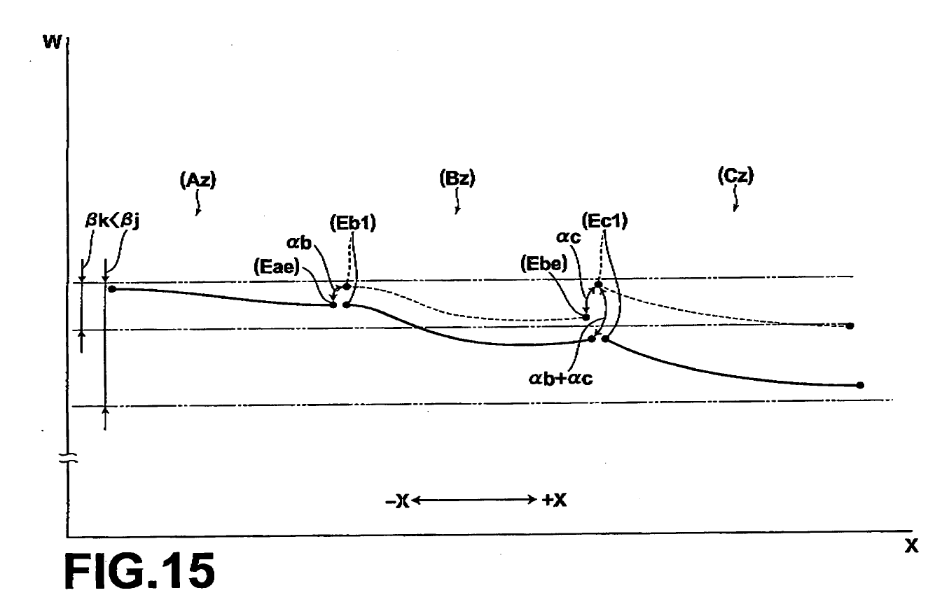

FIG. 12 is a view showing a state where a plurality of line sensors are arranged overlapping each other, and FIG. 13 is a view showing correction of the image data value output from a line sensor arranged overlapping each other. Though, in FIG. 12, the line sensor 20A is spaced from the line sensor 20B and the line sensor 20B is spaced from the line sensor 20C, they are spaced from each other for the reason of drawing the FIG. 12 and are actually in contact to each other.

The following description will be made on the case where the line sensors overlap each other. Since operation of the system where line sensors overlap each other is substantially the same as that of the system where the line sensors which have been described above do not overlap each other, the analogous elements are given the same reference numerals and the same contents will not be described, here.

The photo-sensors out of the photo-sensors forming each of the line sensors which overlap each other in a direction perpendicular to said one direction are disposed to receive the stimulated light from the same or substantially the same area of the stimulable phosphor sheet.

<<Image Data Correcting System 101′>>

Image data correcting system 101′ which is a modification of the image data correcting system 101 will be described with reference to FIGS. 5, 12, 13 and the like, hereinbelow. The elements analogous to those in the above image data correcting system 101 are given the same reference numerals and will not be described.

As shown in FIGS. 5, 12 and 13, the image data correcting system 101′comprises a line sensor group formed by a plurality of line sensors 20A, 20B and 20C arranged to partly overlap each other in a first direction (said one direction) each of which is formed by a number of photo-sensors 10 arranged in the first direction, a line sensor designating portion 82 which determines one line sensor 20A of the line sensor group as a reference line sensor, and determines another line sensor 20B adjacent to the reference line sensor 20A as an object line sensor to be corrected, a first correction value obtaining portion 86 which obtains first correction values Hb1 to Hb3 (Hb1=Hb2=Hb3, sometimes simply referred to as “Hvb”, hereinbelow) for giving to first object image data values Gb1 to Gb3 to be corrected so that the average Avb of the first object image data values Gb1 to Gb3 output from a plurality of first object photo-sensors 10B1 to 10B3 in the end portion 21B1 of the object line sensor 20B facing the reference line sensor 20A conforms to the first reference image data values Gaγ to Gae (γ=e−3) output from first reference photo-sensors 10Aγ to 10Ae in the reference line sensor 20A nearer to an end 21Ae of the reference line sensor 20A facing the object line sensor 20B, the first reference photo-sensors 10A γ to 10Ae overlapping the first object photo-sensors 10B1 to 10B3, a third correction value obtaining portion 88 which obtains third object correction values Hb4 to Hbe which are for correcting the third object image data values Gb4 to Gbe to be corrected and not larger than the first correction value Hvb, the third image data values Gb4 to Gbe to be corrected being output from third object photo-sensors 10B4 to 10Be remoter from a second photo-sensor 10A1 which is in an end portion 21A1 of the reference line sensor 20A opposite to the object line sensor 20B than the first object photo-sensor 10B1, and a correction value giving portion 84 which gives the first correction value Hvb to the first object image data values Gb1 to Gb3 and the third correction values Hb4 to Hbe to the third image data values Gb4 to Gbe, and connects the corrected image data values Gb1′ to Gbe′, the image data values Gb1 to Gbe which have been output from the object line sensor 20B and have been corrected, to the image data values Ga1 to Gae.

<<Modification of the Correction>>

The third correction value may be smaller than the first correction value Hb1.

The first correction value obtaining portion 86 may obtain the first correction value form the difference between the first reference image data and the first object image data, or the ratio of the first reference image data and the first object image data. Further, the first correction value obtaining means 86 may obtain the first correction value on the basis of the difference between the first reference image data value and the first object image data value when the first reference image data value is small while obtains the first correction value on the basis of the ratio of the first reference image data value to the first object image data value when the first reference image data value is large.

The third correction value obtaining means 88 may obtain the third correction value to hold unchanged before and after the correction a representative value of second object image data output from the second object photo-sensor in the object line sensor which are disposed in an end portion of the object line sensor opposite to the reference line sensor. The second object photo-sensor may either comprise a single photo-sensor or a plurality of photo-sensors The representative value is a representative of the second object image data and may be, when the second object photo-sensor comprises a plurality of photo-sensors, an average of second image data values output from the plurality of photo-sensors or one of the image data values output from the plurality of photo-sensors.

As the second object photo-sensor, for instance, a photo-sensor 10Be disposed in an end portion of the object line sensor opposite to the reference line sensor nearest to the end may be employed.

The second object photo sensor may comprise a plurality of photo-sensors 10Bγ to 10Be (γ=e−3) while the representative value is an average of second image data values Gbγ to Gbe output from the plurality of photo-sensors 10Bγ to 10Be.

The third correction value obtaining means 88 may obtain the third correction value to give a smaller correction value as an image data output from a photo-sensor remoter from the second reference photo-sensor.

After causing the control means 80 to cause the correction amount giving means which is the correcting means to execute the correction, the line sensor designating means 82 may designate a line sensor which has been previously object line sensor 20B as a new reference line sensor and a line sensor 20C which has been different from the previous reference line sensor and is adjacent to the new reference line sensor as a new object line sensor.

The line sensors 20A, 20B and 20C are used to detect stimulated light Lk which is emitted from a stimulable phosphor sheet 1 upon stimulation by stimulating light Le and the image data correcting system 101′ and 102′ cause the output calibrating means 25A, 25B and 25C to calibrate the image data output from the line sensors 20A, 20B and 20C so that the image data values output from photo-sensors 10 which receive the stimulated light Lk emitted from the stimulable phosphor sheet 1 is proportional to the amount of radiation which has entered the stimulable phosphor sheet 1.

The line sensor 20B outputs in sequence image data generated by photo-sensors 10 forming the line sensor 20B, the output calibrating portion 25B can calibrate image data output from the line sensor 20B by the use of calibration data made on basis of the image data for calibration output in the latter part out of a plurality of pieces of the image data output in sequence from the line sensor 20B.

The modifications of the correction which are applied to the case where the line sensors are arranged to overlap each other can also be applied to the case where the line sensors are arranged not to overlap each other. Further, the modifications of the correction which are applied to the case where the line sensors are arranged not to overlap each other can also be applied to the case where the line sensors are arranged to overlap each other.

As described above, in accordance with the present invention, accumulation of the correction values each time the line sensors are corrected can be suppressed and the image data values can be connected to be continuous while the width of fluctuation of the image data values output respectively from the photo-sensors forming a plurality of the line sensors is suppressed from increasing.

Further, it is possible to correct the image data in a personal computer in the same manner as the embodiments described above by installing the program for executing the function of the image data correcting system of the present invention in the personal computer.

1. A method of correcting image data which is output from each of photo-sensors forming a plurality of line sensors arranged in a first direction wherein the improvement comprises the steps of
determining one of the plurality of line sensors as a reference line sensor,
determining another line sensor adjacent to the reference line sensor as an object line sensor to be corrected, and
giving a larger correction value to the image data value output from photo-sensor in the object line sensor nearer to an end of the reference line sensor facing the object line sensor so that the image data values output from photo-sensors in the object line sensor near to the end of the reference line sensor is connected to the image data values output from photo-sensors in the reference line sensor near to the end of the object line sensor facing the reference line sensor.

2. A method as defined in claim 1 in which a larger correction value is given to the image data value output from photo-sensor in the object line sensor which is nearer to the end of the reference line sensor with the image data values output from photo-sensor in the object line sensor which is in the end portion opposite to the end of the reference line sensor fixed.

3. A method as defined in claim 1 in which the photo-sensor is a CCD element.

4. A method as defined in claim 1 in which the end portions of line sensors adjacent to each other out of a plurality of the line sensors arranged in the first direction overlap each other.

5. A method as defined in claim 1 in which the line sensor is used to detect stimulated light which is emitted from a stimulable phosphor sheet upon stimulation by stimulating light and represents a radiation image recorded on the stimulable phosphor sheet.

6. A method as defined in claim 5 in which the line sensor outputs in sequence a plurality of pieces of image data generated by the photo-sensors forming the line sensor,
calibration data for calibrating the image data values output from photo-sensors which receive the stimulated light emitted from the stimulable phosphor sheet to be proportional to the amount of radiation which has entered the stimulable phosphor sheet is made by the use of the image data for calibration output in the latter part out of a plurality of pieces of the image data output in sequence, and
each image data output from the line sensors is calibrated by the use of the calibration data thus made.

7. An image data correcting system comprising
a line sensor group formed by a plurality of line sensors arranged in a first direction each of which is formed by a number of photo-sensors arranged in the first direction,
a line sensor designating means which determines one of the plurality of line sensors as a reference line sensor, and determines another line sensor adjacent to the reference line sensor as an object line sensor to be corrected,
a first correction value obtaining means which obtains a first correction value for correcting first object image data to be corrected so that the first object image data value output from a first object photo-sensor in the end portion of the object line sensor facing the reference line sensor conforms to first reference image data value output from first reference photo-sensor in the reference line sensor nearer to an end of the reference line sensor facing the object line sensor,
a third correction value obtaining means which obtains a third object correction value which is for correcting the third object image data value to be corrected and not larger than the first correction value, the third image data value to be corrected being output from a third object photo-sensor remoter from a second photo-sensor which is in an end portion of the reference line sensor opposite to the object line sensor than the first object photo-sensor, and
a correcting means which corrects the first object image data value by the use of the first correction value and the third object image data value by the use of the third correction value.

8. An image data correcting system comprising
a line sensor group formed by a plurality of line sensors arranged in a first direction each of which is formed by a number of photo-sensors arranged in the first direction,
a line sensor designating means which determines one of the plurality of line sensors as a reference line sensor, and determines another line sensor adjacent to the reference line sensor as an object line sensor to be corrected,
a first correction value obtaining means which obtains a first correction value for correcting first object image data value to be corrected so that the average of first object image data values output from a plurality of first object photo-sensors in an end portion of the object line sensor facing the reference line sensor conforms to the average of first reference image data values output from first reference photo-sensors in the reference line sensor nearer to an end of the object line sensor facing the reference line sensor,
a third correction value obtaining means which obtains a third object correction value which is for correcting the third object image data value to be corrected and not larger than the first correction value, the third object image data value to be corrected being output from third object photo-sensors remoter from second reference photo-sensors which are in the end portion of the reference line sensor opposite to the object line sensor than the first object photo-sensors, and
a correcting means which corrects the first object image data values by the use of the first correction value and the third object image data values by the use of the third correction value.

9. An image data correcting system as defined in claim 7 in which the first correction value obtaining means obtains the first correction value on the basis of the difference between the first reference image data value and the first object image data value.

10. An image data correcting system as defined in claim 7 in which the first correction value obtaining means obtains the first correction value on the basis of the ratio of the first reference image data value and the first object image data value.

11. An image data correcting system as defined in claim 7 in which the first correction value obtaining means obtains the first correction value on the basis of the difference between the first reference image data value and the first object image data value when the first reference image data value is small while obtains the first correction value on the basis of the ratio of the first reference image data value to the first object image data value when the first reference image data value is large.

12. An image data correcting system as defined in claim 7 in which the third correction value obtaining means obtains the third correction value to hold unchanged before and after the correction a representative value of second object image data output from the second object photo-sensor in the object line sensor which are disposed in an end portion of the object line sensor opposite to the reference line sensor.

13. An image data correcting system as defined in claim 12 in which the second object photo-sensor is a photo-sensor disposed in an end portion of the object line sensor opposite to the reference line sensor nearest to an end.

14. An image data correcting system as defined in claim 12 in which the second object photo sensor comprises a plurality of photo-sensors while the representative value of the second object image data is an average of the second image data values output from the plurality of photo-sensors.

15. An image data correcting system as defined in claim 7 in which the third correction value obtaining means obtains the third correction value to give a smaller correction value as an image data output from a photo-sensor remoter from the second reference photo-sensor.

16. An image data correcting system as defined in claim 7 in which the line sensor group comprises three or more line sensors and the image data correcting system is further provided with a control means which causes the correcting means to execute the correction after the correction by the correcting means is executed and causes the line sensor designating means to designate a line sensor which has been the object line sensor as a new reference line sensor and a line sensor which has been different from the previous reference line sensor and is adjacent to the new reference line sensor as a new object line sensor.

17. An image data correcting system as defined in claim 7 in which the line sensor is used to detect stimulated light which is emitted from a stimulable phosphor sheet upon stimulation by stimulating light and represents a radiation image recorded on the stimulable phosphor sheet and
the line sensor is provided with a calibrating means for calibrating the image data values output from photo-sensors which receive the stimulated light emitted from the stimulable phosphor sheet to be proportional to the amount of radiation which has entered the stimulable phosphor sheet.

18. An image data correcting system as defined in claim 17 in which the line sensor outputs in sequence image data generated by photo-sensors forming the line sensor, and the calibrating means calibrates the image data by the use of the data for calibration made by the use of the image data for calibration output in the latter part out of a plurality of pieces of the image data output in sequence.

19. An X-ray examining system which is provided with the image data correcting system as defined in claim 7 and executes X-ray examination.

20. A method of correcting image data wherein the improvement comprises the steps of
determining one of a plurality of line sensors of a line sensor group comprising the plurality of line sensors arranged in a first direction each of which comprises a number of photo-sensors arranged in said first direction as a reference line sensor,
determining another line sensor adjacent to the reference line sensor as an object line sensor to be corrected,
obtaining a first correction value for correcting first image data to be corrected so that a first object image data value output from a first object photo-sensor in the object line sensor nearer to an end facing the reference line sensor conforms to first reference image data value output from a first reference photo-sensor in the reference line sensor nearer to an end facing the object line sensor,
obtaining a third correction value which is for correcting a third image data value to be corrected and not larger than the first correction value, the third image data value to be corrected being output from a third object photo-sensor remoter from a second reference photo-sensor which is in an end portion of the reference line sensor opposite to the object line sensor than the first object photo-sensor, and
correcting the first object image data value by the use of the first correction value and the third object image data value by the use of the third correction value.

21. A computer program for causing a computer to execute the method of correcting image data comprising
procedure of determining one of a plurality of line sensors of a line sensor group comprising the plurality of line sensors arranged in a first direction each of which comprises a number of photo-sensors arranged in said first direction as a reference line sensor, and determining another line sensor adjacent to the reference line sensor as an object line sensor to be corrected,
procedure of obtaining a first correction value for correcting first image data to be corrected so that a first object image data value output from a first object photo-sensor in the object line sensor nearer to an end facing the reference line sensor conforms to first reference image data value output from a first reference photo-sensor in the reference line sensor nearer to an end facing the object line sensor,
procedure of obtaining a third correction value which is for correcting a third image data value to be corrected and not larger than the first correction value, the third image data value to be corrected being output from a third object photo-sensor remoter from a second reference photo-sensor which is in an end portion of the reference line sensor opposite to the object line sensor than the first object photo-sensor, and
procedure of correcting the first object image data value by the use of the first correction value and the third object image data value by the use of the third correction value.

22. A computer readable medium in which is recorded a computer program for causing a computer to execute the method of correcting image data comprising
procedure of determining one of a plurality of line sensors of a line sensor group comprising the plurality of line sensors arranged in a first direction each of which comprises a number of photo-sensors arranged in said first direction as a reference line sensor, and determining another line sensor adjacent to the reference line sensor as an object line sensor to be corrected,
procedure of obtaining a first correction value for correcting first image data to be corrected so that a first object image data value output from a first object photo-sensor in the object line sensor nearer to an end facing the reference line sensor conforms to first reference image data value output from a first reference photo-sensor in the reference line sensor nearer to an end facing the object line sensor,
procedure of obtaining a third correction value which is for correcting a third image data value to be corrected and not larger than the first correction value, the third image data value to be corrected being output from a third object photo-sensor remoter from a second reference photo-sensor which is in an end portion of the reference line sensor opposite to the object line sensor than the first object photo-sensor, and
procedure of correcting the first object image data value by the use of the first correction value and the third object image data value by the use of the third correction value.
